(19) United States
(12) Patent Application Publication
(10) Pub. No.: US 2015/0100339 A1
(43) Pub. Date: Apr. 9, 2015

(54) MULTI-USER CLINICAL PATHWAY SYSTEMS WITH THERAPY OPTIONS AND VISUAL NOTICES OF CLINICAL TRIAL OPPORTUNITIES

(71) Applicant: The Charlotte Mecklenburg Hospital Authority d/b/a Carolinas Healthcare System, Charlotte, NC (US)

(72) Inventor: Edward S. Kim, Charlotte, NC (US)

(21) Appl. No.: 14/472,643

(22) Filed: Aug. 29, 2014

Related U.S. Application Data
(60) Provisional application No. 61/886,931, filed on Oct. 4, 2013.

(51) Int. Cl. G06F 19/00; G06Q 50/22

(52) U.S. Cl. CPC G06F 19/325; G06Q 50/22
USPC 705/2

(57) ABSTRACT

The systems, methods and computer program products provide online access to clinical pathways that provide in a convenient, intuitive and user-friendly manner, treatment options with clinical trial enrollment opportunities as well as a bundled or packaged set of supporting documents and data that can facilitate standardized treatments and provide clinicians with identification of and timely and easy access to open clinical trials.

### RELATED APPLICATIONS

This application claims the benefit of and priority to U.S. Provisional Application Ser. No. 61/886,931, filed Oct. 4, 2013, the contents of which are hereby incorporated by reference as if recited in full herein.

### COPYRIGHT NOTICE

A portion of the disclosure of this patent document contains material which is subject to copyright protection. The copyright owner, The Charlotte-Mecklenburg Hospital Authority, doing business as “Carolinas HealthCare System”, Charlotte, N.C., has no objection to the reproduction by anyone of the patent document or the patent disclosure, as it appears in the Patent and Trademark Office patent file or records, but otherwise reserves all copyright rights whatsoever.

### FIELD OF THE INVENTION

The invention relates to systems, methods and computer programs used to provide therapy treatment options to physicians.

### BACKGROUND

Enrollment in research studies and clinical trials remain very low despite efforts to streamline patient recruitment. Physicians have busy clinic days and most are unable to remain aware of the various clinical trials that might be available so as to be able to make timely decisions for respective patients that may benefit from such a clinical trial or research study.

There remains a need for systems that can facilitate a physician's access to treatment options for faster, more efficient and/or improved patient treatment.

### SUMMARY OF EMBODIMENTS OF THE INVENTION

Embodiments of the invention are directed to methods, computer programs and systems that use a computer network to provide a circuit that provides displays of clinical pathways of treatment options with open clinical trials presented on a display adjacent other treatment options for a respective disease such as a cancer.

Embodiments of the invention are directed to methods for providing clinical guidelines using a computer network. The methods include providing a web-based service that provides a clinical pathways system using at least one server that allows users to access the clinical pathways system. The clinical pathways system includes a portal with a plurality of different defined clinical pathways for different diseases. The clinical pathways include treatment clinical pathways that are displayed in a window on at least one display with an open clinical trial presented adjacent other treatment clinical pathways for respective disease. The treatment clinical pathways and any open clinical trial presented can each be selected by a user to electronically access related documents and information useful to initiate a selected therapy.

The web-based service that provides the clinical pathways system can be configured to provide custom clinical pathways for defined hospitals, hospital systems or institutions. The web-based service can be configured to electronically select appropriate clinical pathways to present to a user according to a user's relationship or affiliation with the defined hospital, hospital system or institution.

Open clinical trials can be identified and placed on clinical pathways (shown on a display) in near real time to when a respective clinical trial has been approved by a defined medical board review.

Closed clinical trials can be deactivated, removed or occluded from view on a respective clinical pathway in near real time from closure.

The open clinical trial can be shown on a display in a therapy decision window and/or page adjacent defined conventional treatment clinical pathways.

The different diseases associated with the clinical pathways include a plurality of different cancers.

The clinical pathways can include a series of electronic windows or pages providing diagnostic clinical pathways that are sequentially placed before an electronic window or page providing the treatment clinical pathways.

The diagnostic pathways can include display windows with relevant treatment notes and associated guidelines with electronic links or access to defined documents or information.

A respective open clinical trial can be placed at more than one physical location or in more than one window or page along a clinical pathway for a particular disease and/or in more than one window or page associated with a pre-treatment, front line treatment or post-treatment, in a respective clinical pathway to thereby facilitate doctor awareness of applicability of the clinical trial for different relevant therapy decision points along a clinical pathway.

A respective open clinical trial can be concurrently presented in different clinical pathways for different diseases.

The method can further include electronically automatically notifying a user that previously accessed a disease-specific clinical pathway in the clinical pathway of a system of a newly opened clinical trial for that disease-specific clinical pathway.

The automatic notification can include a hyperlink to a window, page or location associated with the newly opened clinical trial in the clinical pathway.

The method can include providing a list of pending clinical trials on a page or window correlated to a target disease associated with one or more of the clinical pathways.

The method can include providing a research study input and/or notice on a window or page associated with a respective clinical pathway at a location relevant to a specimen needed for the research. The research study input and/or notice providing electronic access to relevant documents can include a patient informed consent form, researcher contact data and any special or noted specimen collection protocol.

The method can include electronically providing a requestor page or pages with a defined standardized set of inputs allowing a user to request that a clinical trial opportunity be included in the clinical pathways system for patient recruitment.

The defined set of inputs can include a drug associated with the clinical trial, related information about the drug and trial, target treatment, patient eligibility information, patient informed consent form, and location of where the requested clinical trial will be carried out.

The method can include electronically providing pending clinical trials on a window or page adjacent associated conventional defined treatment clinical pathways with a visual presentation that is different from the conventional defined treatment clinical pathways and any open clinical trials.

The method can include electronically providing visual indicia of a location associated with where the open clinical trial is being carried out at least when the open clinical trial is carried out away from a patient home or base hospital, hospital system or institution.

The clinical pathways system can be configured to indicate a requestor patient clinical trial as a clinical trial adjacent or in a window of other treatment clinical pathways with visual indicia that the requestor clinical trial is in a remote location away from a patient home base.

Other embodiments are directed to clinical pathways systems. The systems include at least one web server in communication with a global computer network configured to provide a web-based service that hosts a clinical pathways system. The clinical pathways system includes at least one portal for users to access the clinical pathway system. The clinical pathways system is configured to provide a series of electronic pages and/or windows having a visual presentation of clinical pathways associated with a plurality of different disease states. The clinical pathways includes treatment clinical pathways configured to be shown in at least one window and/or page on a display with an open clinical trial presented adjacent other treatment clinical pathways. The treatment clinical pathways and any open clinical trial presented can each be selected by a user to electronically access related documents and information useful to initiate a selected therapy associated with the selected clinical pathway or open clinical trial.

The web-based service can be configured to provide custom clinical pathways for respective defined hospitals, hospital systems or institutions. The web-based service can be configured to electronically select a set of appropriate clinical pathways for presentation to a user according to a user's relationship or affiliation with the defined hospital, hospital system or institution.

Open clinical trials can be identified and placed on a page or window with other conventional defined treatment clinical trial pathways in near real time to when a respective clinical trial has been approved by a defined medical board review.

Closed clinical trials can be deactivated, removed or occluded from view on a respective clinical pathway in near real time from closure.

The different diseases associated with the clinical pathways can include a plurality of different cancers.

The clinical pathways can include a series of electronically generated windows and/or pages with diagnostic clinical pathways associated with the treatment clinical pathways, and wherein the diagnostic pathways include windows and/or pages with relevant treatment notes and associated guidelines with electronic access to defined documents or information.

A respective open clinical trial can be placed at more than one physical location and/or in more than one window or page associated with one or more of a pre-treatment, front line treatment or post-front-line treatment of a clinical pathway to facilitate doctor awareness of applicability of the clinical trial for different relevant therapy decision points along a clinical pathway.

The system can be configured to electronically automatically notify a respective user that has previously accessed a disease-specific clinical pathway of a newly opened clinical trial in that disease-specific clinical pathway.

The automatic notification can include electronic access (e.g., a hyperlink) to a window, page or location in the clinical pathway system associated with the newly opened clinical trial.

The system can be configured to electronically generate at least one page and/or window with a list of open clinical trials correlated to associated target diseases.

The system can be configured to accept a user request to submit a clinical trial opportunity for inclusion in the clinical pathway system for patient recruitment.

The system can be configured to electronically provide a requestor page or pages with a defined standardized set of inputs for integrating a potential clinical trial opportunity into the clinical pathway system.

The system defined set of inputs can include a name of a drug (chemical and/or trade name) associated with the clinical trial, related information about the drug and clinical trial, target disease treatment, patient eligibility information, patient informed consent form, and location of where the requested clinical trial will be carried out.

The clinical pathway system can be configured to visually differentiate a requestor patient clinical trial from adjacent or in a window of other treatment clinical pathways with a visual indicia that the trial is in a remote location away from a patient home base.

The system can be configured to present indicia identifying whether a respective open clinical trial is carried out away from a home hospital, hospital system or institution of the patient.

Still other embodiments are directed to a computer program product, the computer program product includes a non-transitory computer readable storage medium having computer readable program code. The computer-readable program code includes computer readable program code configured to carry out the methods of one or more of the methods described and/or claimed herein (e.g., method claims 1-19).

The computer program product can include computer readable program code configured to provide a clinical pathways system using at least one server that allows users to access the clinical pathways system, wherein the clinical pathways system comprises a portal with a plurality of different defined clinical pathways for different diseases; computer readable program code configured to allow a user to select a desired clinical treatment pathway from one of the defined different clinical pathways for different diseases for displayed in a window or windows on at least one display; computer readable program code configured to present an open clinical trial adjacent other treatment clinical pathways for a respective disease; and computer readable program code configured to provide electronic access to related documents and information useful to initiate a therapy in a selected treatment clinical pathway and any open clinical trial in the selected treatment clinical pathway.

Yet other embodiments are directed to systems with at least one processor comprising computer program code that, when executed, causes the processor to carry out the operations of the methods of one or more of the methods described and/or claimed herein (e.g., method claims 1-19).

The systems can include at least one processor that has computer program code, that when executed, causes the at least one processor to: (a) provide a clinical pathways system using at least one server that allows users to access the clinical pathways system, wherein the clinical pathways system comprises a portal with a plurality of different defined clinical pathways for different diseases; (b) allow a user to select a desired clinical treatment pathway from one of the defined different clinical pathways for different diseases for displayed in a window or windows on at least one display; (c) present an open clinical trial adjacent other treatment clinical pathways for a respective disease; and (d) provide electronic access to related documents and information useful to initiate a therapy in a selected treatment clinical pathway and any open clinical trial in the selected treatment clinical pathway.

The systems, methods and computer program products provide online access to clinical pathways that provide in a convenient, intuitive and user-friendly manner, treatment options with clinical trial enrollment opportunities as well as a bundled or packaged set of supporting documents and data that can facilitate standardized treatments and provide clinicians with identification of and timely and easy access to open clinical trials.

Embodiments of the invention can be configured to allow clinicians including doctors to generate webmails, establish an online interactive session (such as using SKYPE or other camera or audio or audiovisual system or other electronic communications) from the system directly to contact research personnel associated with a clinical trial of interest, such as via a window, link or portal provided by the system thereby not requiring a separate email contact or separate telephone call to initiate a clinical trial inquiry.

Embodiments of the present invention provide a web-based service that hosts a system allowing a distributed network of users to use client-server architecture. Management and support of the system can be separate. The system can allow users with different access privileges to communicate and interact with the system in different ways.

As will be appreciated by those of skill in the art in light of the above discussion, the present invention may be embodied as methods, systems and/or computer program products or combinations of same. In addition, it is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE DRAWINGS

FIG. 1 is an exemplary screen shot of a user interface (UI) or window of a clinical pathways system according to embodiments of the present invention.

FIG. 2 is an exemplary screen shot of a UI or window of a clinical pathways system illustrating information revealed by selecting a corresponding treatment pathway according to embodiments of the present invention.

FIG. 3A is an exemplary screen shot of a UI or window of a clinical pathways system illustrating an active-enrollment of available of one or more clinical trials as a respective treatment pathway according to embodiments of the present invention.

FIG. 3B is an exemplary screen shot of a UI or window of a clinical pathways system illustrating a closed clinical trial, a pending clinical trial and a remote (e.g., out of state or external to a base hospital or hospital system) clinical trial identified according to embodiments of the present invention.

FIG. 4 illustrates the screen shot or window shown in FIG. 1, but with a research study selected which generates instructions/specifications for collection of research specimens required by protocol according to embodiments of the present invention.

FIG. 5 is a schematic illustration of a web-based system according to embodiments of the present invention.

FIG. 6 is an exemplary screen shot of a UI or window with a portal and disease list for selecting a desired clinical pathway along with an exemplary notice that can be sent to a user when a new clinical trial opportunity is identified or becomes available according to embodiments of the present invention.

FIG. 7 is an exemplary screen shot of a UI or window with a listing of open clinical trials and optional pending clinical trials for respective pathways according to embodiments of the present invention.

FIG. 8 is a schematic illustration of user devices with APPs that communicate with a clinical pathways system according to embodiments of the present invention.

FIGS. 9-17 are exemplary UI windows of content of a clinical pathways system for lung cancer according to embodiments of the present invention.

FIG. 18 is a schematic illustration of a data processing system according to embodiments of the present invention.

FIG. 19 is a flow chart of exemplary operations/steps that can be used to carry out embodiments of the present invention.

FIGS. 20-24 are exemplary windows or pages of content of a clinical pathways system for melanoma according to embodiments of the present invention.

### DETAILED DESCRIPTION OF EMBODIMENTS OF THE INVENTION

The present invention will now be described more fully hereinafter with reference to the accompanying figures, in which preferred embodiments of the invention are shown. This invention may, however, be embodied in many different forms and should not be construed as limited to the embodiments set forth herein.

Like numbers refer to like elements throughout. In the figures, layers, regions and/or components may be exaggerated for clarity. Broken lines illustrate optional features or operations unless specified otherwise.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the data or information in use or operation in addition to the orientation depicted in the figures. For example, if data in a window view of the system in the figures is inverted, elements described as “under” or “beneath” other elements or features would then be oriented “over” the other elements or features. Thus, the exemplary term “under” can encompass both an orientation of over and under. The display view may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

The term “patient” refers to the individual(s) being examined and/or treated.

The term “clinical pathway” and derivatives thereof means an electronic, programmatically generated, visual presentation on a display that provides defined (i) diagnosis pathways with evaluations, which can include one or more of initial, clinical, pre-treatment and post-surgical evaluations, for staging of cancers, and/or (ii) treatment pathways with treatment options for respective diseases, typically for cancers.

Respective clinical pathway can include a visual identification of any approved clinical trial opportunity at one or more relevant treatment locations along the clinical pathway, particularly at a treatment clinical pathway. A user can access the visual identification (e.g., via a hyperlink) to a data file with selection criteria and other relevant clinical trial information. The clinical trial option can be provided as a text or icon notice on a window or display screen on the clinical pathway adjacent to other defined treatment options.

The term “physical location” when used with respect to an item or feature of the clinical pathway system visual presentation refers to a defined location on a window or page.

The term “window” refers to an electronic window of a user interface (UI) that may be provided on a display that provides visual/textual content. The window may fill the display screen or populate a segment thereof.

The term “page” refers to content of a window, window segment or thumbnail, and the like.

Embodiments of the present invention are directed to systems that provide a plurality of clinical pathways for different diseases, such as different cancers. By way of example, the systems can provide between about 15-30 or even more different cancer clinical pathways including clinical pathways for cancer of the bladder, breast, colorectal, esophageal, gastric, kidney, prostate, rectal, testis, head-and-neck, and the pancreas as well as melanoma, sarcoma, neuorendocrine tumors, small-cell and non-small cell lung cancers and/or hepatocellular carcinoma, among others. Table 1 below provides a list of pathways with respect to exemplary disease or study types as well as other therapy or categories for which clinical pathways may be provided or that may appear on one or more respective pathways.

TABLE 1

| Pathways | Disease |
|---|---|
| Neuro | |
| GU | Bladder |
| | Prostate |
| | Testis |
| | Kidney |
| Upper GI | Esophagus |
| Lower GI | Colon |
| | Colorectal |
| | Gastric |
| Hepatobiliary | |
| Head and Neck | Oropharynx |
| | Hypopharynx |
| | Supraglottic Pharynx |
| | Ethmoid Sinus Tumors |
| | Glottic Larynx |
| | Occult Primary |
| | Salivary Gland Tumors |
| Thoracic | Non-Small Cell Lung Cancer |
| | Small Cell Lung Cancer |
| Breast | |
| Melanoma | |
| Sarcoma | |
| Phase I | |
| Palliative Care | |
| Indigent | |
| Disparities | |
| Bone Tumors | |
| Nursing | |
| Pharmacology | |
| Geriatric | |
| Heme Malignancies | Leukemia |
| | Lymphoma |
| | Myeloma |
| Pheresis | |
| Benign Hematology | |
| Sickle Cell | |
| Gyn Tumors | |
| Biopsy/Tissue Procurement | |
| Blood Collection | |

The systems can also provide clinical pathways for phase I studies and palliative care.

The systems can also provide clinical pathways for hematology, including acute myeloid leukemia and chronic myeloid leukemia.

An approved clinical trial can be presented at one or more treatment decision locations along a respective clinical pathway.

The term “approved” with respect to clinical trials means approved by an authorized internal or external Medical Review Board.

As used herein, the terms “substantially real time” and “near real time” are used interchangeably to mean within 24 hours, typically within about 1-12 business hours of when a clinical trial has been approved or closed. For example, when a clinical trial identified on the clinical pathways systems is closed for enrollment, the clinical pathways system can remove it or indicate it as closed in the affected respective treatment pathway(s) within 24 hours, typically within about 1-12 business hours of when a respective clinical trial has been closed.

The term “automatic” means that substantially all or all of the operations so described can be carried out without the assistance and/or manual input of a human operator. The term “electronic” means that the system, operation or device can communicate using any suitable electronic media and typically employs programmatically controlling the communication between participants using a computer network. The term “programmatically” means the action is directed via computer program code. The term “hub” means a node and/or control site (or sites) that controls and/or hosts data exchange between different user sites using a computer network. The term “HIPAA” refers to the United States laws defined by the Health Insurance Portability and Accountability Act.

The terms “healthcare data” and “clinical data” and “patient records” are used interchangeably and include any and/or all of treatment, medicinal, drug or prescription use, laboratory tests and/or results, diagnostic information, personal information, a home address, insurance information other relevant data associated with a patient.

The term “APP” refers to a computer program configured to provide defined functionality on a computer including pervasive computing devices such as an electronic notebook or notepad, smart phone, lap top, and the like, typically provided via the use of one or more icons on a display to open or access the functionality of the APP.

The term “registered” means that the user is a recognized (authorized) participant of the system. The term “administrative user” refers to a user that does not perform clinical actions or clinical services and is typically a user that does not have permission to access patient medical records. Different types of administrative users can have different access levels to the system.

The terms “web-based” and “online” mean that the service is available using the World Wide Web (Internet), typically via least one server to communicate with different users. The communication protocol can include hypertext transfer protocol (HTTP).

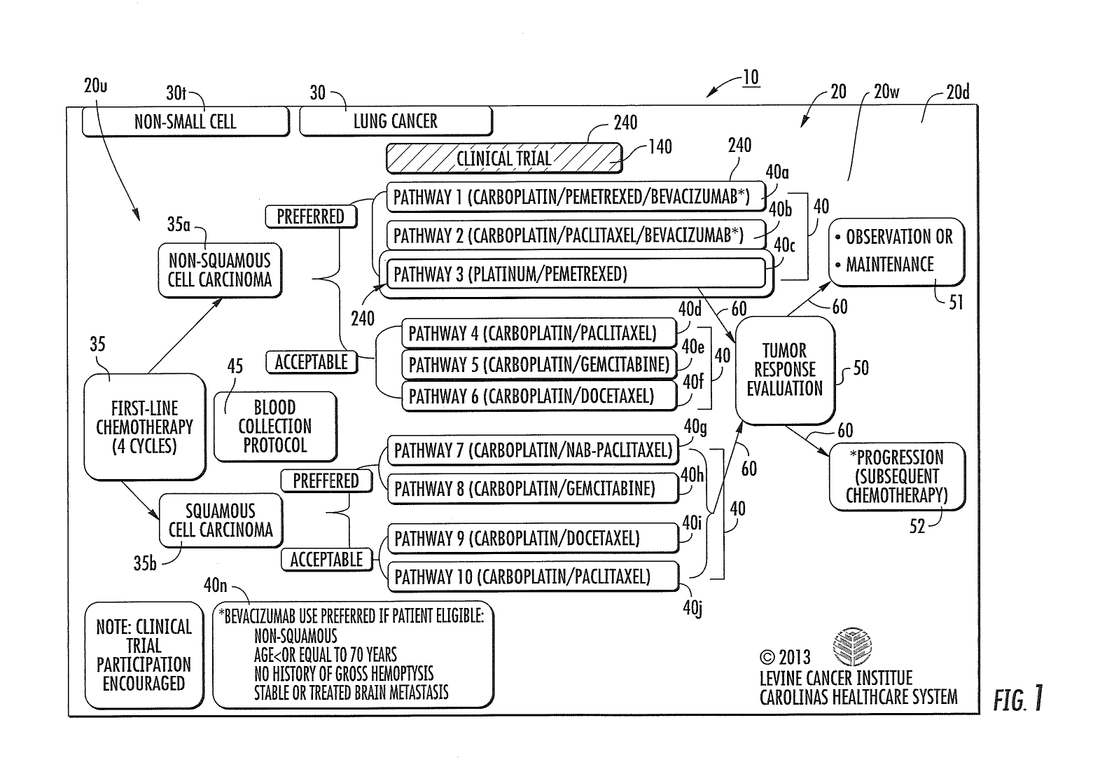

Turning now to the figures, FIGS. 1, 2, 3A, 3B and 4 illustrate examples of a clinical pathway system 10 having a defined set of clinical pathways 20 presented on a display 20d. The system 10 provides relevant treatment pathways 40 for a disease 30, shown as lung cancer, by disease type, shown as non-small cell 30t. The clinical pathways 20 shown in FIGS. 1-3A, 3B and 4 are treatment clinical pathways 40 for stage IV non-small cell lung cancer.

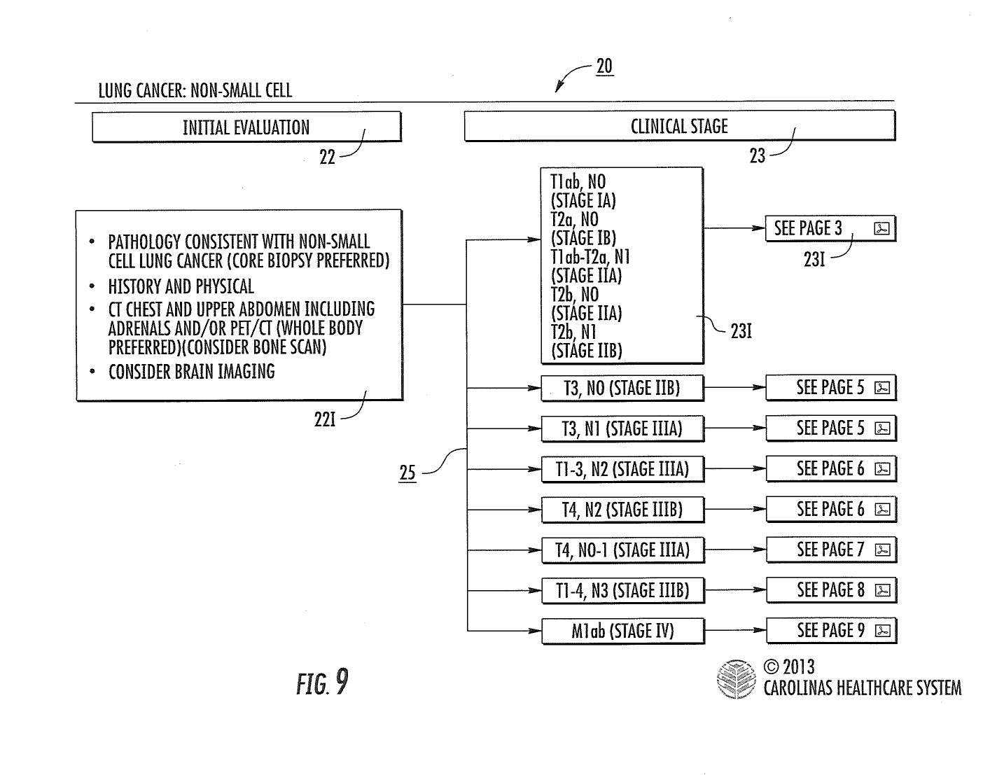

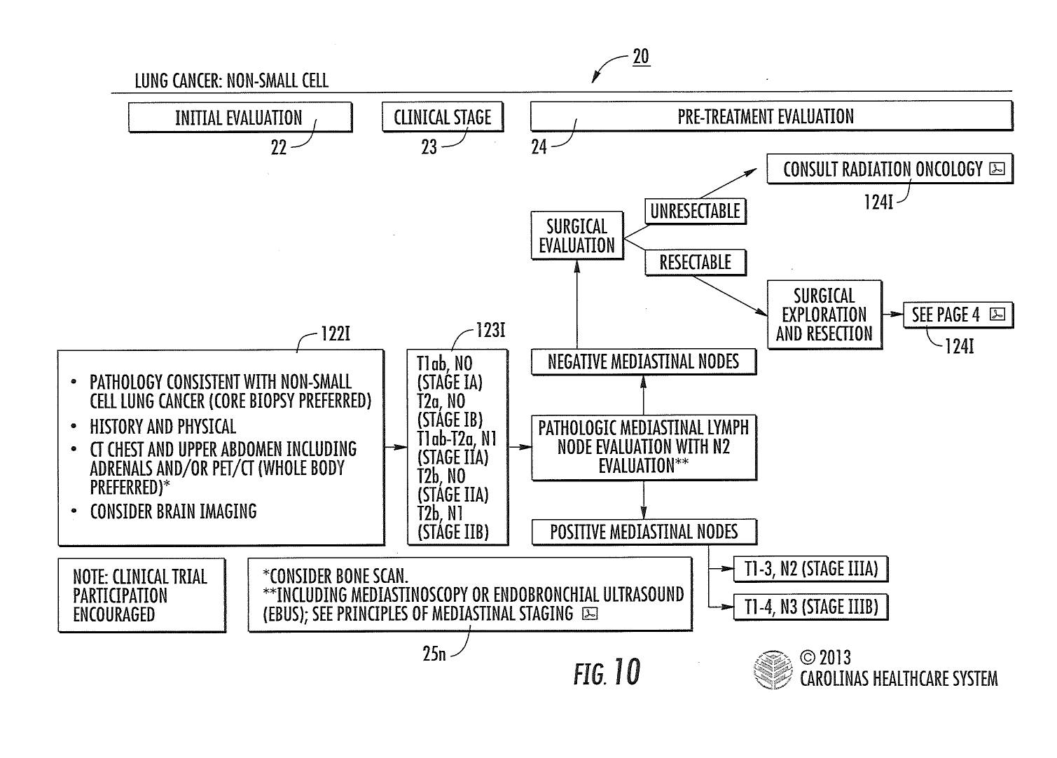

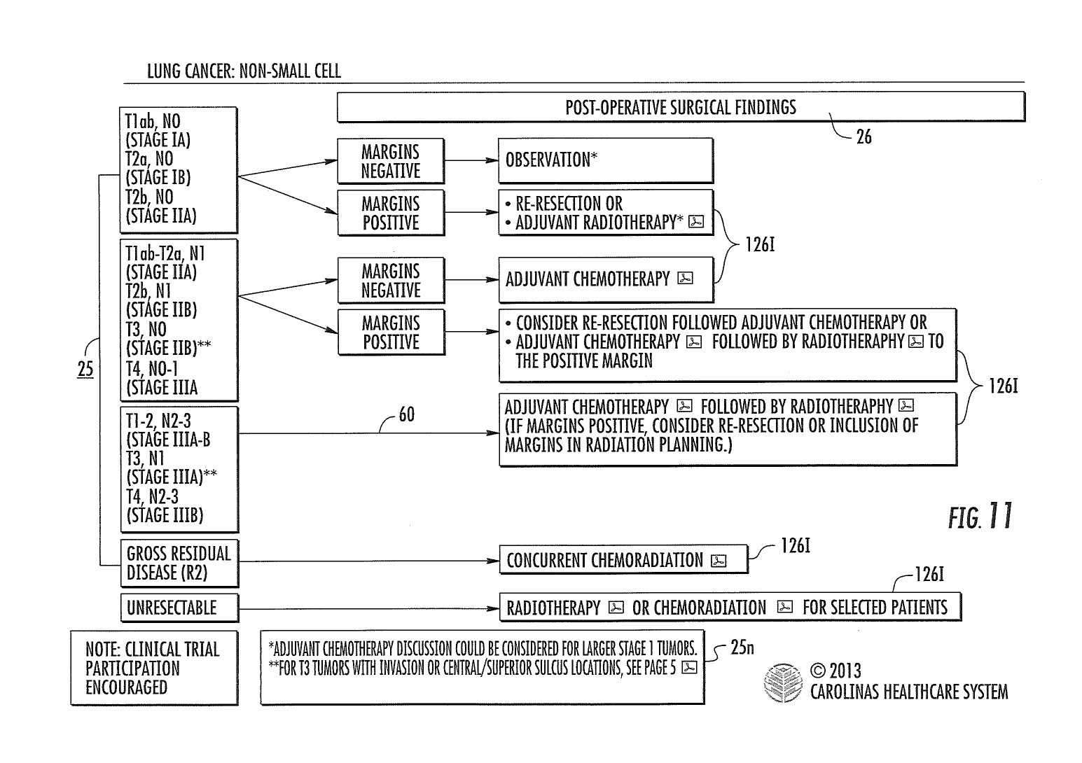

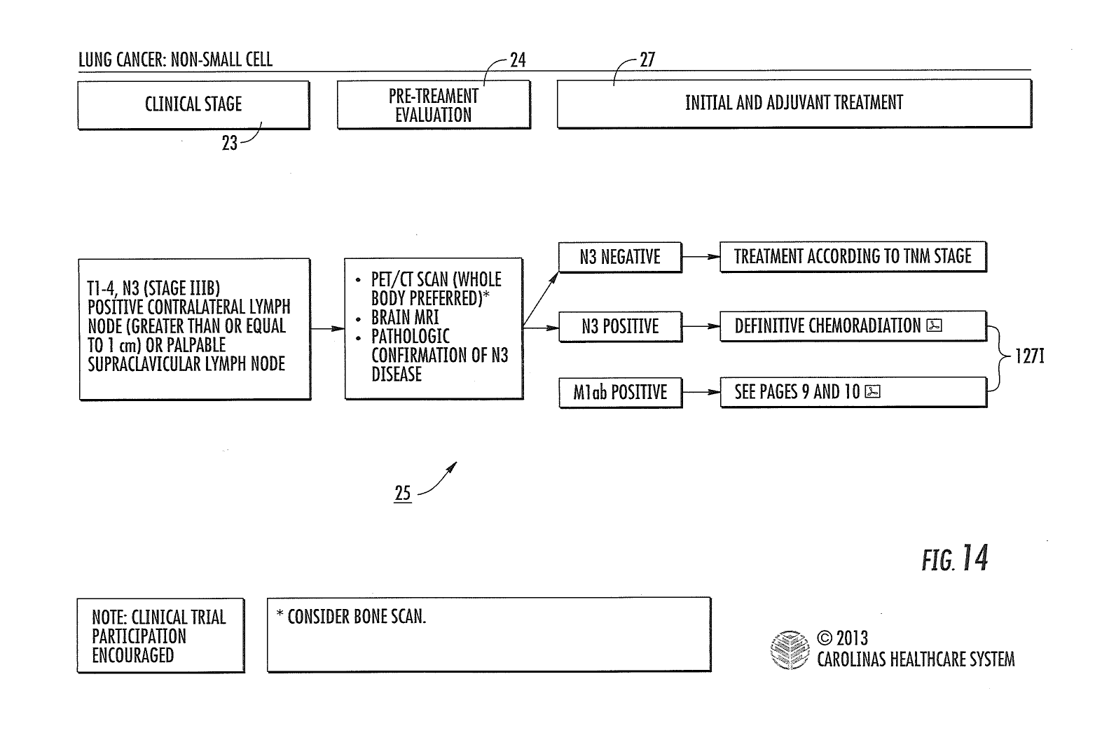

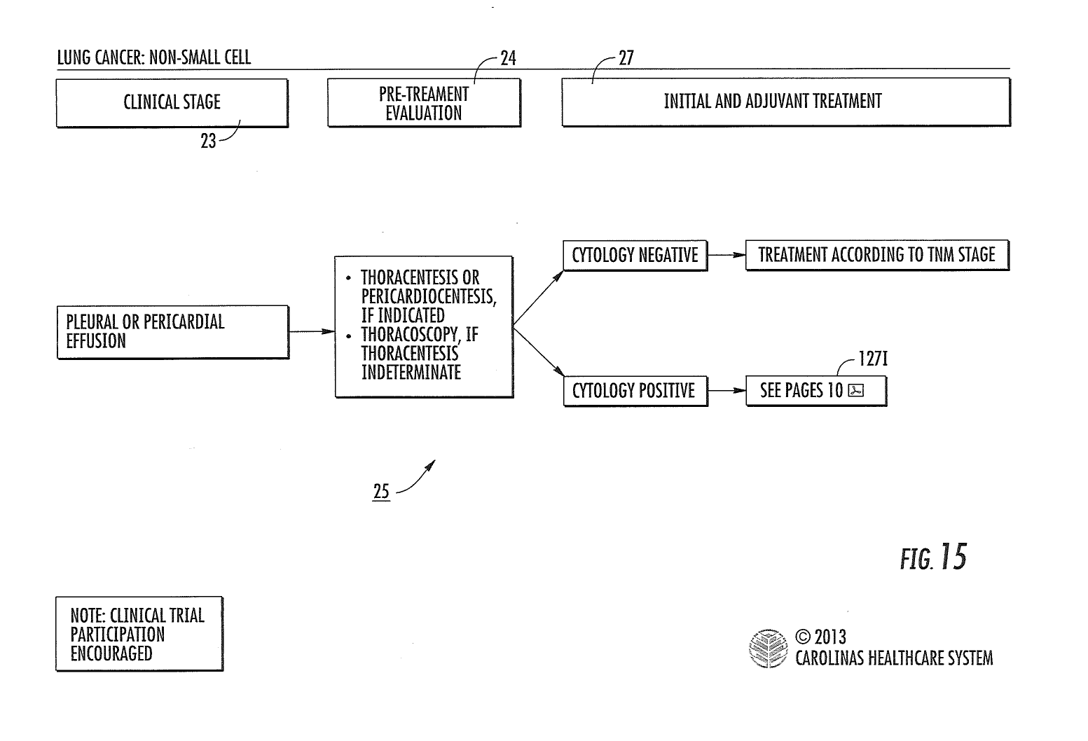

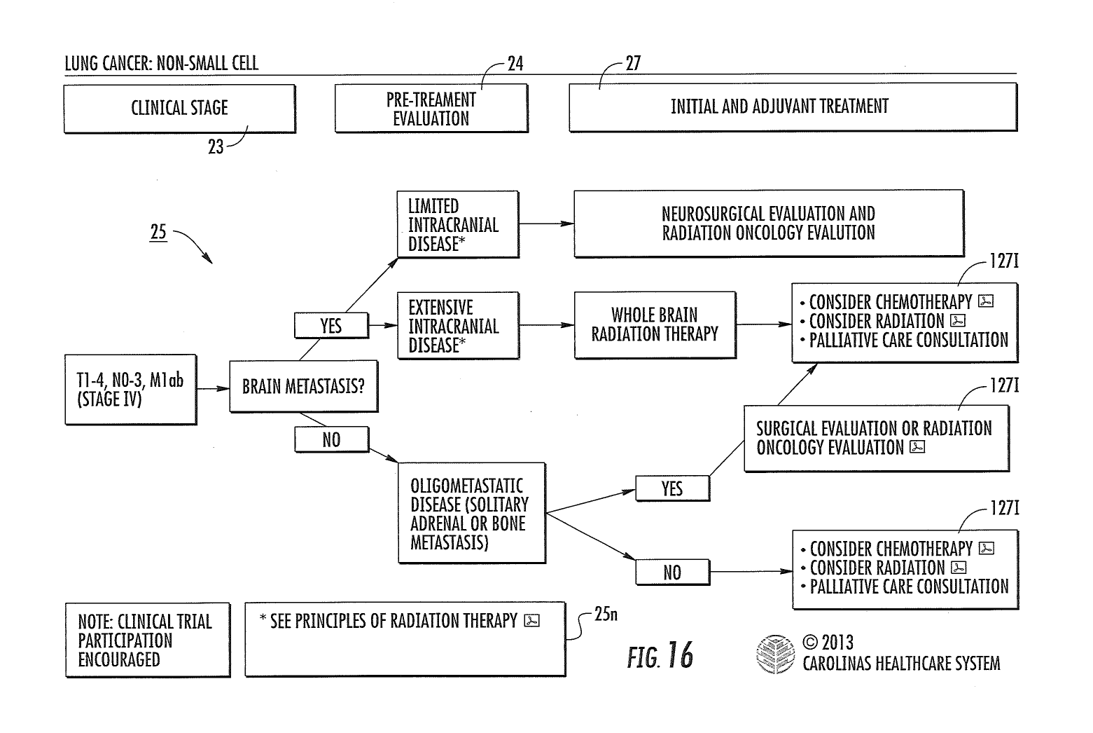

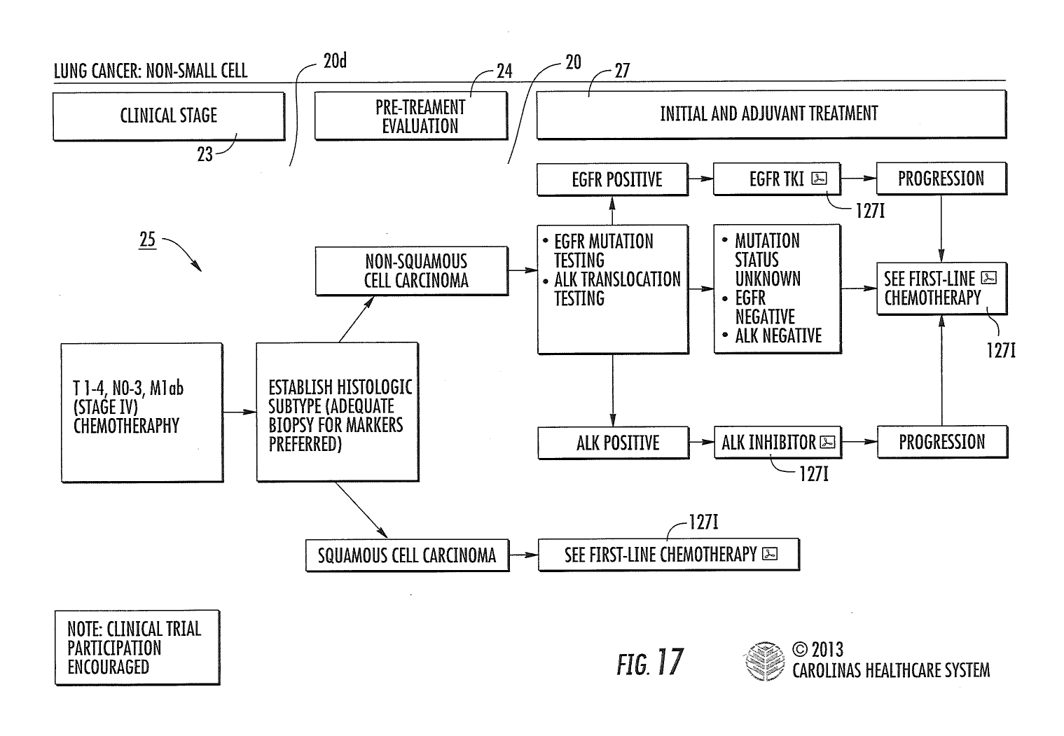

As shown in FIGS. 9-17, the clinical pathways 20 can include diagnosis pathways 25 which can include one or more of an initial evaluation guideline 22, clinical staging guidelines 23, pre-treatment evaluations 24 and post-operative surgical finding guidelines (FIG. 11) that can be sequentially provided in windows related to the treatment clinical pathways 40, in a typical order of use.

Turning back to FIGS. 1, 2, 3A and 4, the clinical treatment pathways 40 can be grouped as “preferred” or “acceptable” according to national or institutional-specific guidelines. The groupings can be carried out via labels as shown and/or using a color-coded indication, e.g., dark green to light green, color saturation, intensity and/or hue associated with preferred ranking order.

The pathways 40 and/or the preferred or acceptable classifications, and/or rank order or visual presentation of same, can be defined or customized for a respective hospital, hospital system and/or institution. The system 10 can be configured so that pathways 40 for a particular hospital, hospital system and/or institution can be automatically selected and shown to a particular user on a display 20d, based on a password or user log-in or other defined data that correlates a user to a hospital, hospital system and/or institution, for example.

The number of different treatment clinical pathways 40 can vary over time and/or for a particular disease 30 and/or disease type 30t, but typically includes at least one preferred and at least one acceptable for a disease subtype 35a, 35b, e.g., 40a, 40b or 40c for non-squamous cell carcinoma 35a, and e.g., 40g, 40h for squamous cell carcinoma 35b, and at least one acceptable, e.g., 40d, 40e or 40f for non-squamous cell carcinoma or 40i, 40j for squamous cell carcinoma 35b. In the embodiment shown in FIGS. 1-4, there are 10 clinical pathways for treatment for the first-line chemo therapy, identified as 40a-40j.

As shown, where an open enrollment clinical trial 140 exists it can be provided adjacent the other treatment clinical pathways 40. In some embodiments, the clinical trial opportunity 140 can be provided as a text box or other graphic or visual/textual presentation at the top of the display 20, typically above the first pathway (e.g., pathway one) 40a to visually emphasize the clinical trial to encourage participation. The clinical trial option 140 can be presented in a visually enhanced manner such as via highlight, a different color, a different color background and/or perimeter, or combinations of same, relative to other pathways 40. The open clinical trial can also be provided as an overlay or tab on a bottom, side or top of the display window or as an icon or blinking indicator representing an open clinical trial is identified as appropriate for the treatment decision point in the treatment clinical pathway.

In some embodiments, the system 10 can be configured to allow clinicians including doctors to generate webmails, establish an online interactive session (such as using a computer calling service and/or a video calling or video chat service such as SKYPE, FACETIME, TANGO, ZOOM.us or VIBER, or other camera, audio or audiovisual system or other electronic communications) from the system directly to allow a clinician, e.g., doctor to contact research personnel associated with a clinical trial of interest, such as via a window, link or portal provided by the system thereby not requiring a separate email contact or separate telephone call to initiate a clinical trial inquiry. A visual “contact me now” user input, such as an icon that is associated with contact numbers and/or email addresses, can be provided on a window for a display or the “contact” electronic communication can automatically occur when a doctor selects and/or opens a clinical trial icon or other input on a display to allow the selection to initiate the communication to the contact research personnel associated with a respective clinical trial opportunity.

As shown in FIG. 1, notes 40n of relevance correlated to a particular path or paths 40 can be presented on the display 20d, shown as under the pathways 40. The notes 40n can be presented in text boxes or in other visually helpful manner. The notes 40n can include input for patient eligibility for selection into a particular defined clinical treatment pathway 40 if patient eligibility meets a defined characteristic or characteristics. The defined characteristic(s) can be a genetic marker, genotype, age, and disease type, for example.

Tethers 60, such as tethers with arrows, can be used to visually indicate decision or categorization points 35a, 35b and/or next steps 50-52. Following the first-line treatment 35 and selected treatment pathway 140 40, tumor response evaluation 50 is shown with next steps 51, depending on this evaluation.

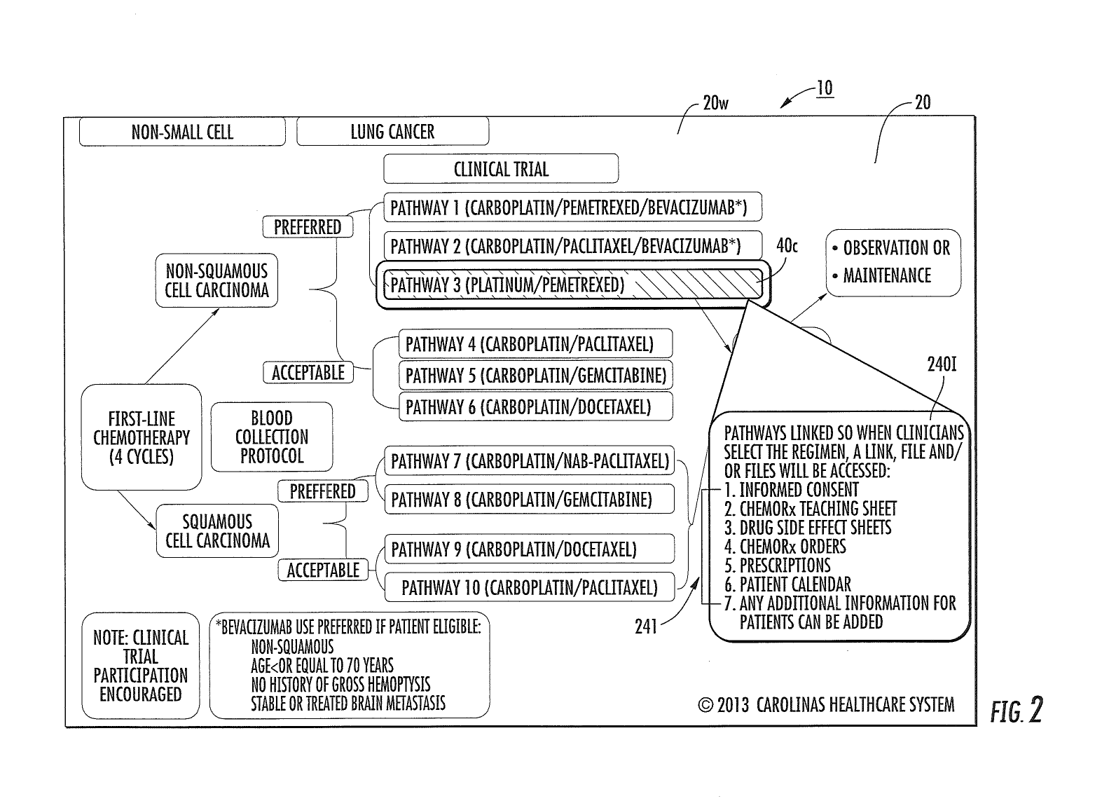

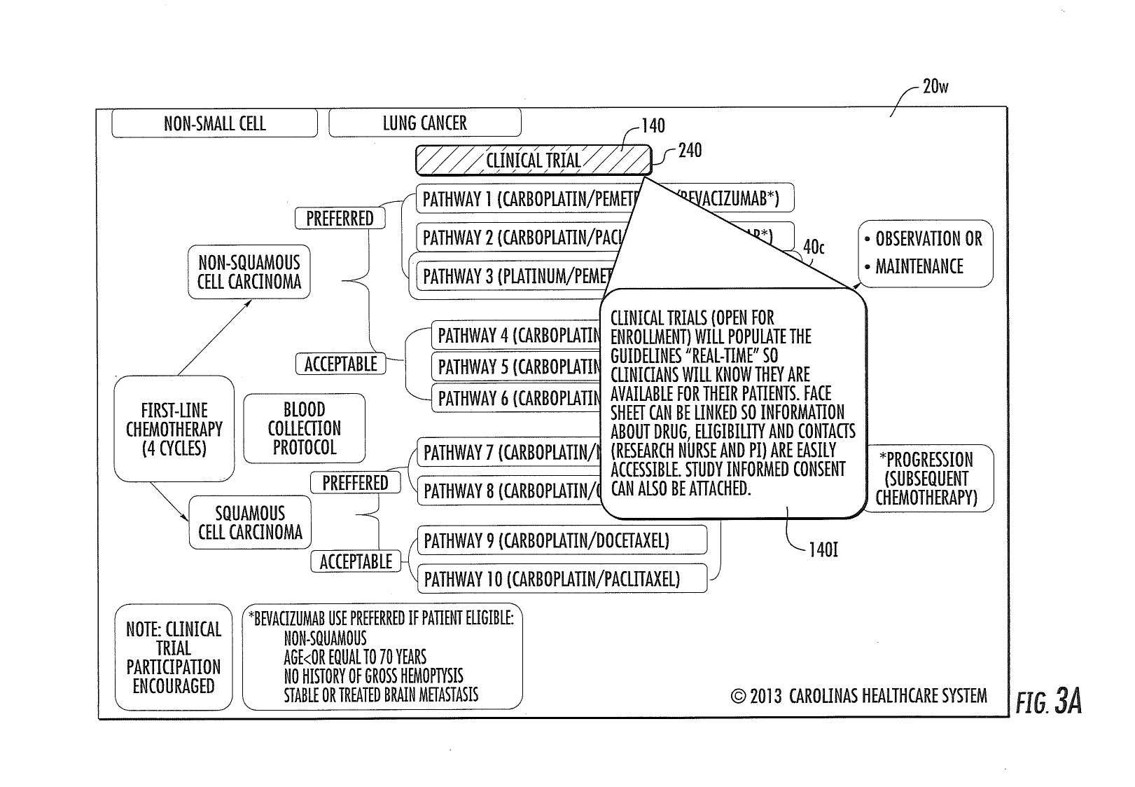

Each of the treatment clinical pathways 40, as well as the clinical trial option or pathway 140, can be configured to electronically provide access to associated relevant data and information 140I, 240I as shown in FIGS. 2 and 3A, for example. The system 10 can be configured to provide substantially all information and supporting documents for respective pathways 40 and clinical trials 140 to treat and educate a patient in one convenient and intuitive system by providing electronic access to and/or placing relevant materials 140I, 240I at a correlated pathway location(s) in a window 20w on the display 20d. The clinical pathways 20 can be provided with a sequential layout of decision points and actions from initial evaluation, staging (if cancer) and treatment (preliminary, primary, adjuvant and follow-up) with arrows and/or visual links that allow for intuitive understanding of the guidelines. The associated materials may be provided as documents in any electronic form, shown by way of example only as PDF formatted documents.

The systems 10 can be configured to accept user input via UI 20u to interactively react to a user's selection of a treatment clinical pathway 40, clinical trial 140, or diagnostic clinical pathway 25 (FIGS. 9-11). Thus, for example, the system 10 can allow a user to select a pathway 40 and/or clinical trial 140 to automatically reveal related information. The access can be provided via hyperlinks, tabs, pull down menus or appended documents “hidden” or remote until selected. The documents or information 240I and/or 140I can be provided as one or more of ZIP FILES, TIFF, JPEG, WORD or PDF documents or other relevant document and/or document types and/or formats.

The UI 20u can comprise voice activation such as an audible verbalization with commands, e.g. “select pathway 2” as well as or alternatively, a tactile or graphic user input, e.g., touch screen or touch gestures, mouse click and the like.

As shown in FIG. 2, the data or documents 240I provided based on an electronically selected treatment pathway 40 can include substantially all information and supporting documents required to initiate therapy. For example, the clinical pathway system 10 can electronically provide informed consent documents (electronic or paper), chemotherapy prescriptions, drug toxicity data, patient education information (teaching sheets), a calendar for scheduling radiography or chemotherapy or for a patient to have dates of the scheduled therapy, other prescriptions for selection (e.g., for pain and/or nausea) and the like to provide a standardized set of documents and information to facilitate a rapid initiation of patient therapy and provide efficient use of clinical time.

The system 10 can be configured with active display regions or links 240 that can access the information 240I for a selected pathway 20 (diagnosis pathway 25, FIGS. 9-11) or treatment pathway 40 (FIGS. 1-4) via one or more hyperlinks, a pull down menu, or other data or image file by selecting the pathway or option 40, 140 using the UI 20u. FIG. 2 illustrates pathway 3 40c selected. This selection by a user can then automatically present or provides electronic access to associated materials such as forms, documents and/or information 241 and the like that conveniently allows the clinician to start a standard or clinical trial treatment regimen without requiring further clinical time to discuss options to initiate such a therapy.

Referring to FIGS. 3A and 3B, the system 10 is configured to provide a display window 20w with the treatment clinical pathways 40 and clinical trials 140 (where available and active). The display options can be provided in near real time so that options for treatment change as clinical trials come online or close. As shown in FIG. 3A, when a clinical trial is indentified as “open”, when a user selects the clinical trial pathway 140, all the information 140I a clinician requires to enroll a patient in the clinical trial can be conveniently provided. The clinical trials open for enrollment can populate the clinical pathway system 10 in near real time so that a user can be confident that the trials are available for their patients, allowing a more efficient use of clinical time. A face or cover sheet can be electronically provided and/or linked so that information about the drug in the clinical trial 140 is provided along with eligibility and contact data for those administrating the trial (e.g., research nurse and/or Principal Investigator). An informed consent document for the clinical trial study can also be provided. The clinical trial information can typically be provided on a single window of a display with links, attached documents or files, or on a set of windows that can be serially accessed using a UI such as touch gesture, click or mouse input.

FIG. 3B illustrates a closed first clinical trail 140c with visual indicia 140v indicating it is closed. The visual indicia 140v can include an icon, text, overlay, markings, color, inactive link, “faded” or occluded view that indicates to a user that the clinical trial is closed. When “closed” the clinical trial opportunity can alter from a visual presentation associated with when it is active. The “closed” clinical trial can be configured to “fade”, “disappear” or be removed, or be visually occluded from a viewing window so that a physician readily knows when a trial is open. In some particular embodiments, the link 240 for a respective clinical trial 140 can be deactivated when closed or just be removed from the display window 20w.

In some embodiments, a “notice” using visual indicia of closure can be placed over the closed clinical trial and the like. In some embodiments, the closed clinical trial can be presented in different manners based on proximity in time to its closure. For example, a “closed” stamp or overlay may be used for a first time period such s about 1 week from closure, then the closed clinical trial can be removed from the display window.

The system 10 can be configured to provide a list of closed clinical trials that were previously shown on the display window 20w in a “closed” list accessible via a link, tab, pull down menu or on a page of the system. The system 10 can be configured to provide links to subsequent journal articles or summaries of the outcomes of the closed trials on one or more window or page of the system for clinical reference. A notice or alert can be electronically sent to a clinician when such a posting or link is placed in the system 10.

The clinical pathways 20 can be configured to identify in near real time when an approved clinical trial opportunity 140 opens and the identification can be physically placed to be presented in a display 20d adjacent a decision point for a therapy, e.g., at a first, second and/or third pass treatment stage associated with the clinical trial, typically placed alongside on the same screen or a common window with other treatment clinical pathways 40.

The physical correlation to the appropriate use point and condition can provide a more intuitive and easy to use system relative to conventional notices, which can be on “paper” or uncorrelated to a treatment point on a clinical pathway.

The clinical pathways 20 can be configured to identify where and when a clinical trial opportunity 140 exists along a respective clinical pathway within about 24 hours of approval by a Medical Review Board associated with the clinical pathway system 10.

The enrollment status of a respective clinical trial 140 can be color-coded to represent when a trial has many vacancies, lesser vacancies and/or when it is closed. The enrollment status can be provided with an appended measure that represents the populated status of the trial (from 0-100%).

In some embodiments, as shown in FIG. 3B, a clinical trial that is not yet approved but that may be targeted for submitting for approval in the future, typically in the next few months or within the year or one that is pending-approval or pending submission for approval, e.g., a “pending clinical trial” 142 may be shown as a potential future treatment option and this future option may be visually presented at one or more locations along the clinical pathway using a defined color or with an appurtenant notice “pending approval” or the like.

FIG. 3B also illustrates that there is a pending clinical trial 142 that has not been approved but that may be approved in the near future. This allows a clinician to have up to date information regarding clinical trials that may go online in the future, typically within 1 week to 6 months. The pending clinical trial 142 can be provided with other treatment clinical pathways 40 or may be provided as a note 40n on a display window 20w or pull down menu or tab, for example.

FIG. 3B also illustrates that visual indicia of location 142l can be provided when a clinical trial (whether open or pending) is to be carried out at a remote location (shown as “NY”). An icon indicating the trial is to be carried out at a remote location may also or alternately be used (e.g., a geographically shaped map of the US or a particular state or just a text note of “remote”). This may help a clinician confer with the patient on travel limitations and the like before or along with other patient eligibility criteria for more efficient use of clinical time.

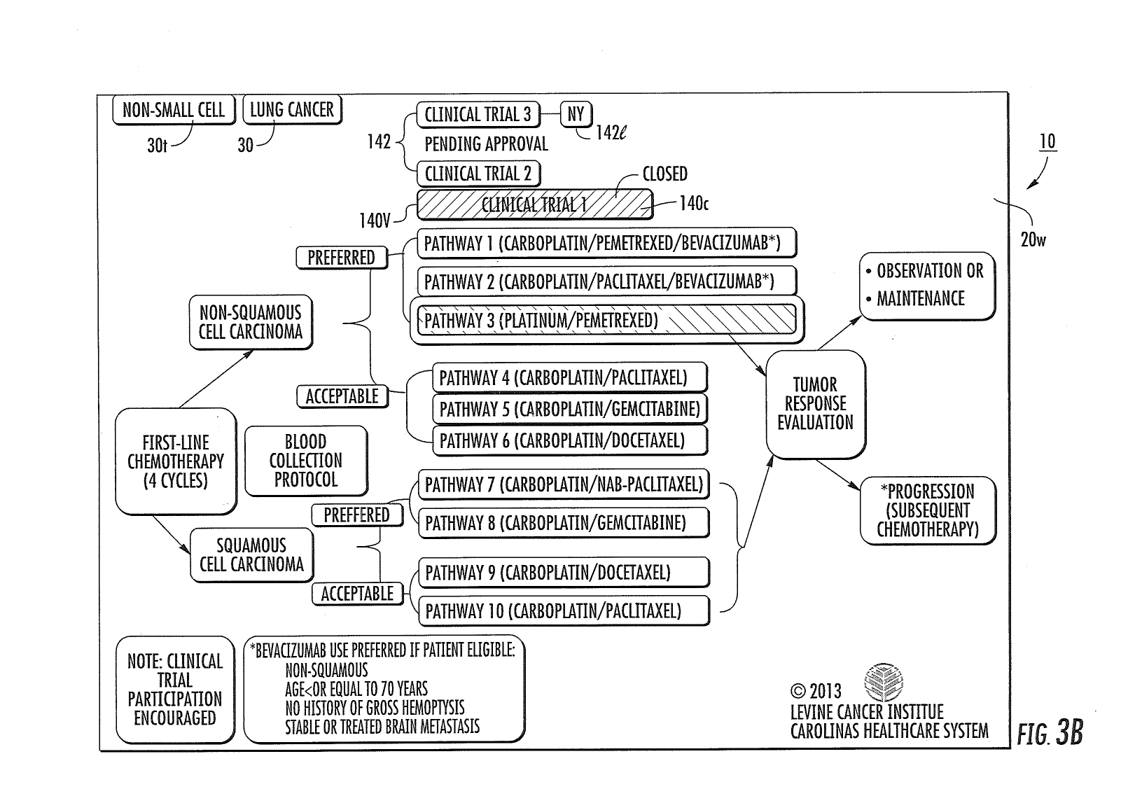

FIG. 4 illustrates that the system 10 can provide a research information input 45, shown as box 45b, on the display 20 for identifying research specimens desired by an institution, hospital or investigator, the research input 45 can be linked to instructions for the desired collection of specimens 145 (blood, urine, tissue and the like) with an informed consent document and research (clinician) contact.

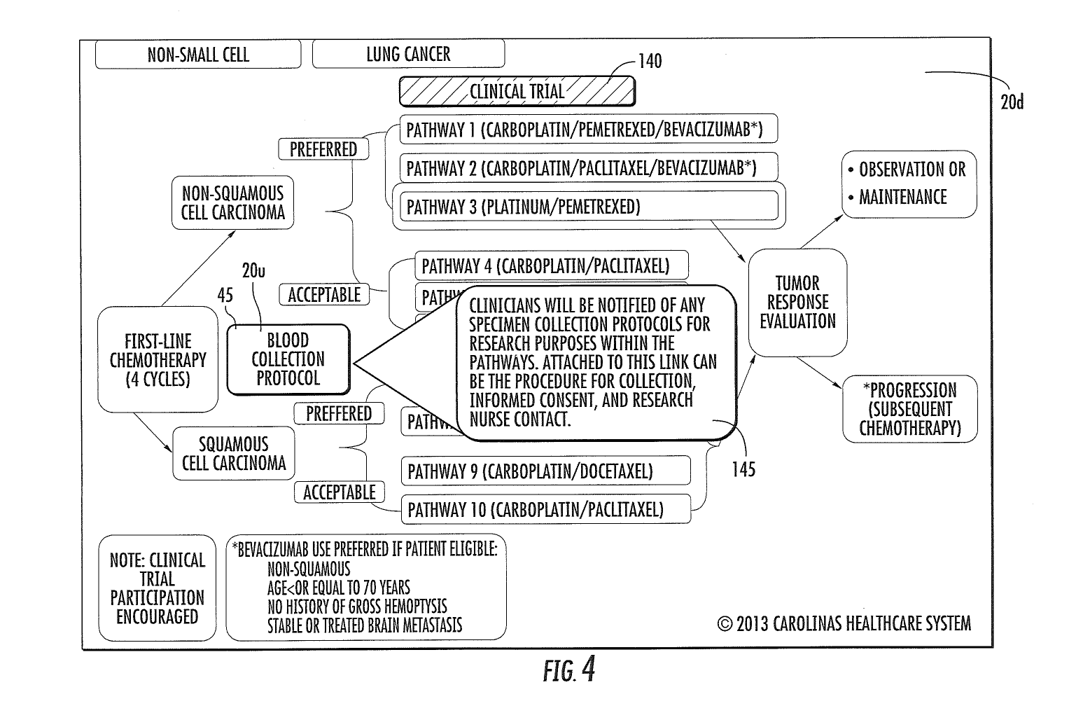

FIG. 5 illustrates the clinical pathway system 10 that can be provided using the Internet 300 and at least one server 301. A plurality of different clinical sites can be in communication with the at least one server 301 hosting or providing the clinical pathways system 10. The at least one server 301 can allow access to multiple user from different clinical facility sites or the same clinical facility at any one time. The clinical pathway systems 10 can use a computer network with a distributed, client-server architecture. The system 10 can be accessed via any desired device having access to the Internet 300 including wireless communication systems (such as cellular telephones or smartphones), PDAs, desktop or portable computers including lap or handheld computers, electronic tablets or notebooks and the like.

FIG. 5 also illustrates that the system 10 can include a clinical trial patient enrollment module 306 that can be held on the same server 301 as all or part of the system 10 or held on a separate server, router or database. The clinical trial patient enrollment module 306 can provide a count of patients enrolled. This count can be used to electronically automatically “close” the trial or alter the appearance of an open trial as the trial closes. However, the closed status of respective trials may be tracked in other manners.

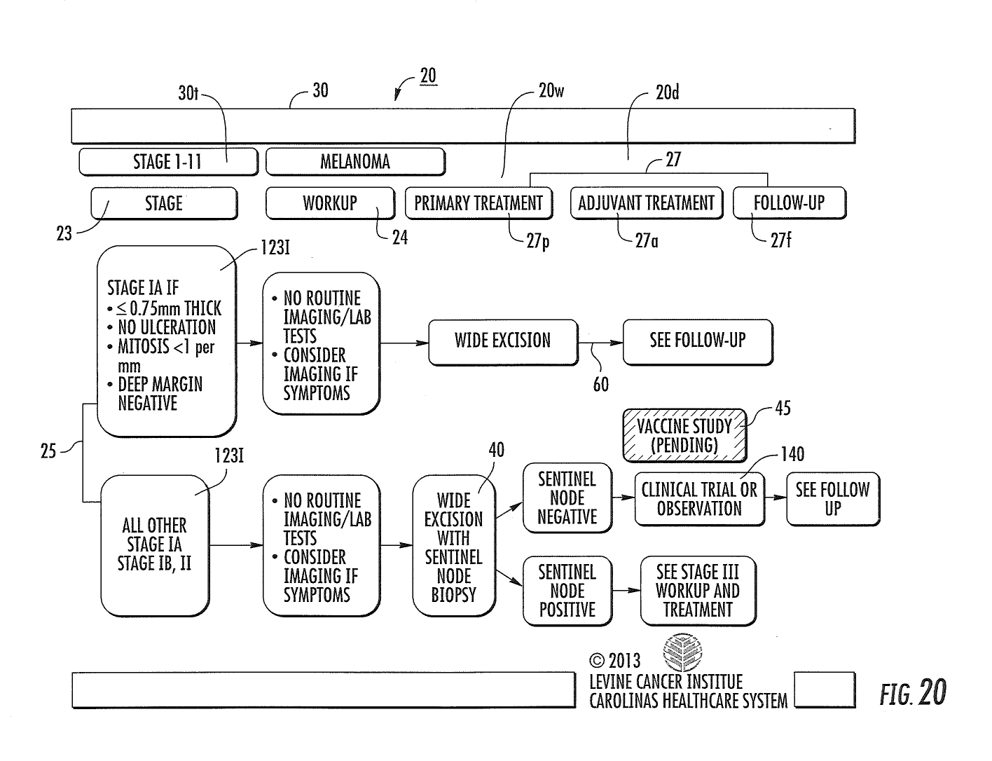

Embodiments of the invention are configured so that a clinical trial 140 (e.g., ECOG 1609 in FIGS. 20-24) can appear multiple times at various decision points and/or pathways to visually let doctors know that enrollment of patients can occur at multiple places.

Embodiments of the invention may use a computing architecture in which the user interface, the application processing logic, and/or the underlying database(s) can be encapsulated in logically-separate processes. In any given application utilizing this type of computing architecture, the number of tiers may vary depending on the requirements of the particular application; thus, such applications are generally described as employing a n-tier architecture. See, e.g., Exforsys.com, N-Tier Client-Server Architecture. For instance, some embodiments of the invention may employ a 2-tier architecture, commonly referred to as a client-server architecture, wherein a client application such as a web browser makes a request from a web server, which processes the request and returns the desired response (in this case, web pages). Other embodiments of the invention may be structured as a 3-tier or other larger multi-tier architecture, wherein the web server provides the user interface by generating web pages requested by a web browser, which receives and displays code in a recognized language such as dynamic HTML (Hypertext Markup Language); middleware executing on an application server handles the business logic; and database servers manage data functions. Often, the business logic tier may be refined into further separate tiers to enhance manageability, scalability, and/or security.

Accordingly, in some web-based clinical pathway systems or hosted services, the web applications can use a 2-tier or 3-tier architecture with a presentation tier that provides the different clinical pathways. The web application tiers may be implemented on a single application server, or may be distributed over a plurality of application servers. The presentation tier can provide web pages that allow a user to access different clinical pathways using a common portal presented on local client devices such as local desk top or laptop computers, smartphones, electronic notebooks or personal computing devices and the like. The presentation tier may communicate with other tiers in the application such as the business logic tier and/or clinical trial or patient record data tier by accessing available components or web services provided by one or more of the other application tiers. The presentation tier may communicate with another tier to allow authorized users to access patient record data and/or database stored procedures, instructions, or protocols. The business logic tier can coordinate the application's functionality by processing commands, scheduling tests and evaluating data. The functionality of the business logic tier may be made accessible to other application tiers by, for example, the use of web services. The business logic tier may also provide the logic, instructions or security that can separate and distinguish clinical users from non-clinical users (e.g., administrative users). Where patient data is incorporated or accessed by the clinical pathway systems, a patient data record tier can hold the private patient records data and encapsulate such records from unapproved parties so as to comply with HIPAA or other privacy regulations. The patient records data tier can make data available through, for example, stored procedures, logic, instructions and the like accessible, for example, by web services.

As shown in FIG. 5, the system 10 can include at least one server 301 and a plurality of web clients 305₁-305n (with “n” being an integer number corresponding to the number of participating or registered users). Typically “n” is greater than 10, more typically, n is between 100-10,000, or even more, corresponding to the number of registered users.

The at least one web server 301 can include a single web server as a control node (hub) or may include a plurality of servers (not shown). The system 10 can also include routers (not shown). For example, a router can coordinate privacy rules on data exchange or access. Where more than one server is used, different servers (and/or routers) may execute different tasks or may share tasks or portions of tasks. For example, the system 10 can include one or combinations of more than one of the following: a security management server, a registered participant/user directory server, a patient record management server, a scheduling server, and the like. The system 10 can include firewalls 350 and other secure connection and communication protocols. For Internet based applications, the server 301 and/or at least some of the associated web clients 305 can be configured to operate using SSL (Secure Sockets Layer) and a high level of encryption. Additional security functionality may also be provided. For example, incorporation of a communication protocol stack at the client and the server supporting SSL communications or Virtual Private Network (VPN) technology such as Internet Protocol Security Architecture (IPSec) may provide for secure communications to further assure a patient's privacy.

The system 10 can be provided using cloud computing which includes the provision of computational resources on demand via a computer network. The resources can be embodied as various infrastructure services (e.g., compute, storage, etc.) as well as applications, databases, file services, email, etc. In the traditional model of computing, both data and software are typically fully contained on the user's computer; in cloud computing, the user's computer may contain little software or data (perhaps an operating system and/or web browser), and may serve as little more than a display terminal for processes occurring on a network of external computers. A cloud computing service (or an aggregation of multiple cloud resources) may be generally referred to as the “Cloud”. Cloud storage may include a model of networked computer data storage where data is stored on multiple virtual servers, rather than being hosted on one or more dedicated servers.

The systems 10 may include a web portal 10p that controls participant access. The web portal 10p may be configured to be user-specific based on defined privacy or privilege levels of the user. That is, each web client 305 can display a different web portal 10p configuration and/or different web pages associated with a specific user type (showing different permissible actions, commands and data options).

The server 301 can provide a centralized administration and management application. The server 301 can be configured to provide session management, tracing and logging systems management, workload management and member services. The server 301 can include or communicate with a plurality of databases including participant/user profiles, a security directory, routing security rules, and patient records. The server 301 can include several sub-servers for integration into web systems, such as, but not limited to, a web application server (WAS) which may comprise an IBM WebSphere Application Server, a Directory Server such as an LDAP directory server, and may include an Anonymous Global Patient Identifier (AGPI) Server, a DB2 Server, and a Simple Mail Transfer Protocol (SMTP) Server. It is noted that although described herein as “servers” other suitable computer configurations may be used. The server 301 can be configured with web application functions that appear at portal sites 10p. The server 301 may comprise and/or be configured as a Web Sphere Business Integration (WBI) server. The web server 301 can include a web-based administration application. The web application can be used to: allow a user to register as a participant, manage Access Control Lists (ACLs), logon using universal ID or password access, logoff, define profile preferences, search, approve clinical trial requests and the like.

The web clients 305 can be associated with different users and different user categories or types. Each category or type may have a different “privilege” or access level to actions or data associated with the systems 10. For example, the systems 10 can include clinician users, administrative users, and accounting users, each of which can have different access levels or restrictions to data and/or actions allowed by the system.

The system 10 can include a patient record database and/or server that can include electronic medical records (EMR) with privacy access restrictions that are in compliance with HIPPA rules due to the client-server operation and privilege defined access for different users.

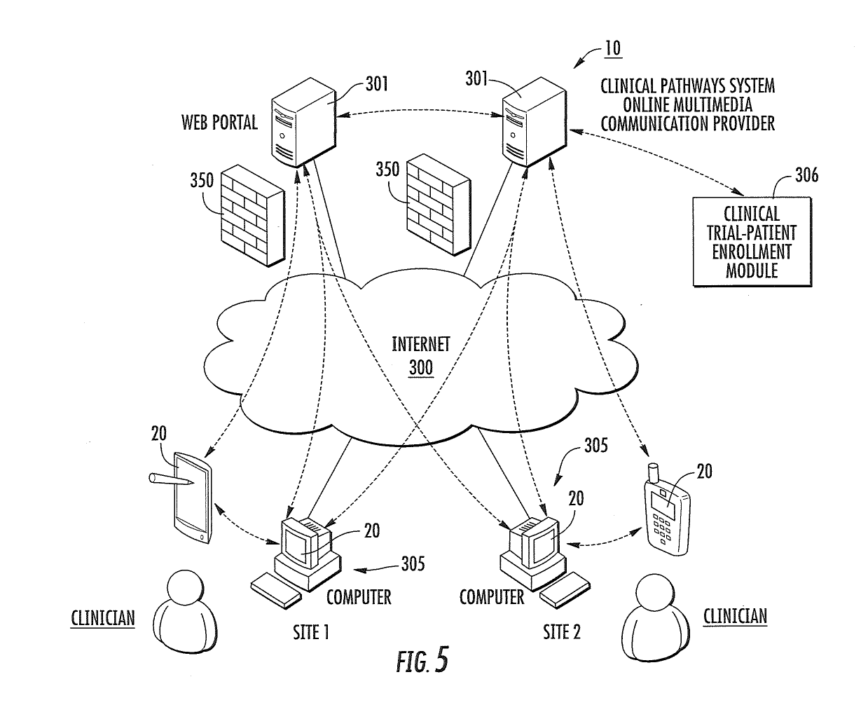

FIG. 6 illustrates an example of a portal 10p providing access to the clinical pathway system 10. The portal 10p can be configured with a list of disease categories having associated defined clinical pathways 20 shown as a plurality of diseases 30 and at least one having a disease subtype 30t. The system 10 may present a password requirement 10e to control access to the system. The list of diseases can be accessed by a user, e.g., provided as an electronically selectable list, pull down menu or other user selectable inputs, e.g., that may be accessed by a graphical or other user input (UI) 30i.

The system 10 can provide differently configured pathways 20, 25 and/or 40 and/or different clinical trial options 140 for different hospitals, hospital systems or institutions and the user password or other user identification may define what set of pathways 20, 25, or 40 and/or trials 140 will be provided. Different actions or window presentations can be provided depending on the user or user affiliation with a particular hospital, hospital authority or institution. The portal can require password entry or other types of restricted access for certain data access.

As also shown in FIG. 6, the system 10 can be configured to automatically transmit alerts, messages or emails 10m to notify a prior or registered user when a new clinical trial opens. The automatic transmit can be based on a correlation of a user to a particular clinical pathway 20, e.g., a window of a particular disease 30 and/or a particular treatment clinical pathway 40, within a prior time period, such as within the last 30 days. The transmission 10m can include an electronic link, e.g., a hyperlink, or other access path back to a relevant point in the treatment clinical pathway 40 (updated now to indicate the open trial) or may just provide the notice (or both).

The system 10 can allow a user to opt in or opt out of the automated alerts. The system 10 can be configured to send a text message or email alert when a trial opens and/or when a trial closes for a specialty or subspecialty selected in a user profile that can be identified when a user registers to use the system 10. In other embodiments, the system 10 can send the alerts out based on where a user has previously accessed a clinical pathway for a respective disease associated with the new or closed trial.

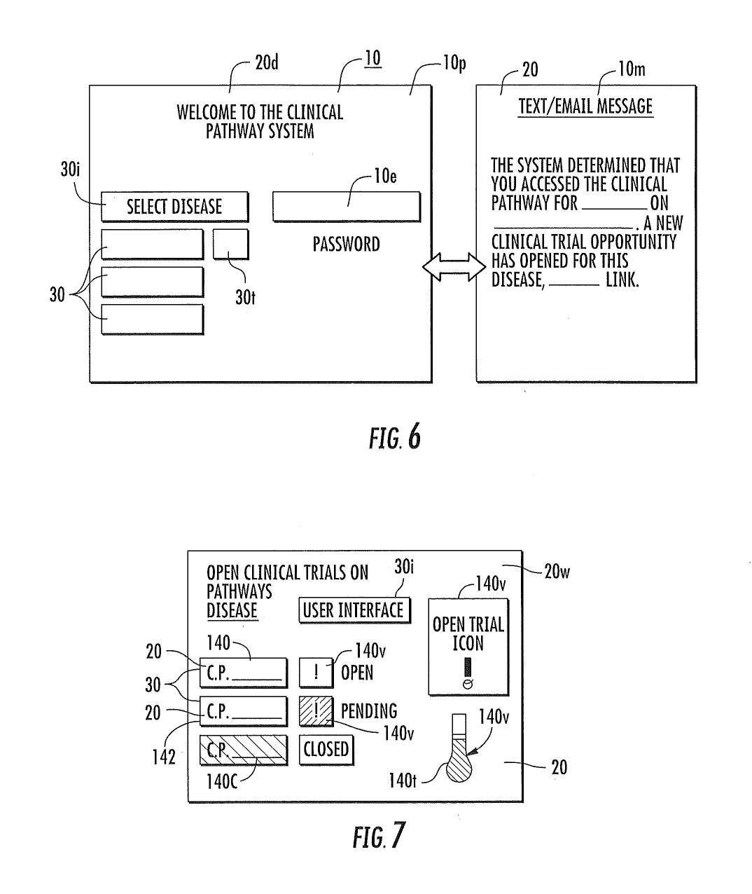

FIG. 7 illustrates that the system 10 can provide at least one window 20w that summarizes open clinical trials 140 and may include all open and optionally all pending trials 142 and/or trials that are deemed relevant for a particular user. The trials 140, 142 can be organized to be shown in a respective window 20w by a defined disease 30 (and may apply to more than one disease or disease type) for facilitating user understanding of relevance to their practice. The indication of pending or open may include visual indicia 140v such as an open “icon” or an icon with a color or letter or text representing “open enrollment status” such as an “O” letter or word for open, and/or a defined color icon, e.g., a green icon, for example. The visual indicia 140v for respective open trials can be configured to visually indicate how full the study is and/or time to closure date, by color coding the icon and/or or by use of a “thermometer” 140t or other visual indicator that visually indicates the populated status and/or timeline to closure of enrollment.

The system 10 can be configured to show recently (e.g., within the last year, typically the last few months or weeks) closed clinical trials 140c in the window 20w (or in a separate or adjacent window) (e.g., FIGS. 3B, 7).

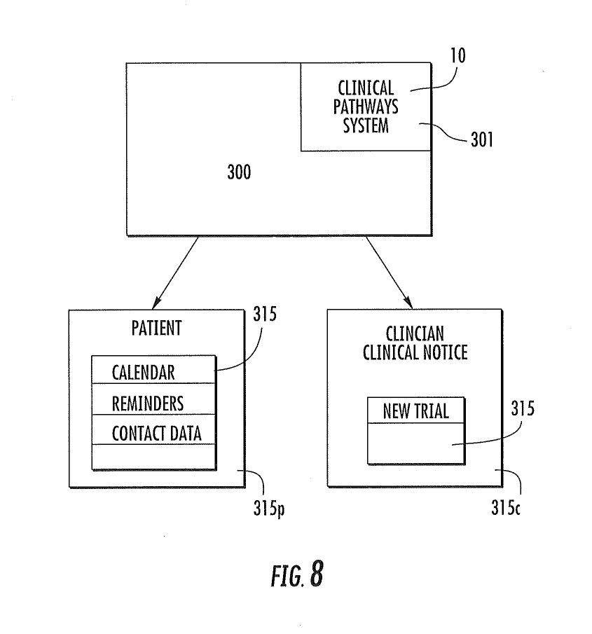

FIG. 8 illustrates that the system 10 can be configured to provide at least one clinical pathway system APP 315. The system 10 can be configured to provide one APP for clinicians 315c and one clinical pathway system APP for patients 315p as shown. The patient APP 315p can provide patient related documents, patient therapy scheduling appointments, links to maps for a scheduled therapy location, automated reminders of appointments, patient educational materials and the like.

The APP 315p can communicate with the system 10 allowing the relevant information and documents to be sent via email or as a text message or documents to a smartphone, tablet, IPAD, notebook or other portable electronic device and/or to a defined computer.

The clinician APP 315c can be configured to receive alerts for new clinical trials as they open and the clinician can customize what alerts he or she receives so that only relevant clinical trial alerts are sent to a particular user.

The clinician APP 315c can also be configured to employ services related to online multimedia communications that may be provided by a third-party online multimedia communications service provider, which may be, e.g., a consumer videoconferencing service provider such as Skype, Microsoft Live Messenger, Yahoo! Messenger, America Online Instant Messenger, or Apple iChat that connects the clinician to the PI, nurse or researcher for ease of interaction to facilitate enrollment or follow-up.

In some embodiments, the clinical pathway systems 10 can be configured to allow pharmaceutical companies or researchers to request placement on a respective clinical pathway 20 for recruitment in a clinical trial 140. These requests can be placed at the appropriate locations along a clinical pathway 20. These requests may be for patient recruitment and may be required to be submitted in a standardized format and with standardized content for use in the clinical pathway systems 10. A set of guidelines or documents with standardized content documents can be provided by the system 10 to facilitate standardization for incorporation into the clinical pathway system 10. To request posting in the system 10, the system 10 can be configured with a set of standard criteria and decision options such as disease type and treatment (first round or post first round) for cancers, for example. These decisions can be provided as rules requiring selection from a defined menu of options so that the system 10 can more easily incorporate the requests when appropriate.

The clinical pathway systems 10 can be presented to visually identify third party and/or pharmaceutical company requests for patient recruitment in a different manner from a specific hospital, hospital system or institution MRB-approved clinical trial opportunities. The clinical pathway systems 10 can identify these types of clinical trials as pending clinical trials 142 or in a different manner to visually identify these types of trial requests.

If a clinical trial 140, 142 will be offered at a specific location away from the “home” clinic or hospital. The location and distance away from the “home” clinic may be specified in the attached information 140I and/or as an icon or map or indicator on the clinical trip option 140, 142 as “remote” or with a letter or icon identifier such as “R”, or with a state abbreviation or some other identifier 142l (FIG. 3B) so that a clinician/doctor can discuss the potential travel distance for participation with the patient.

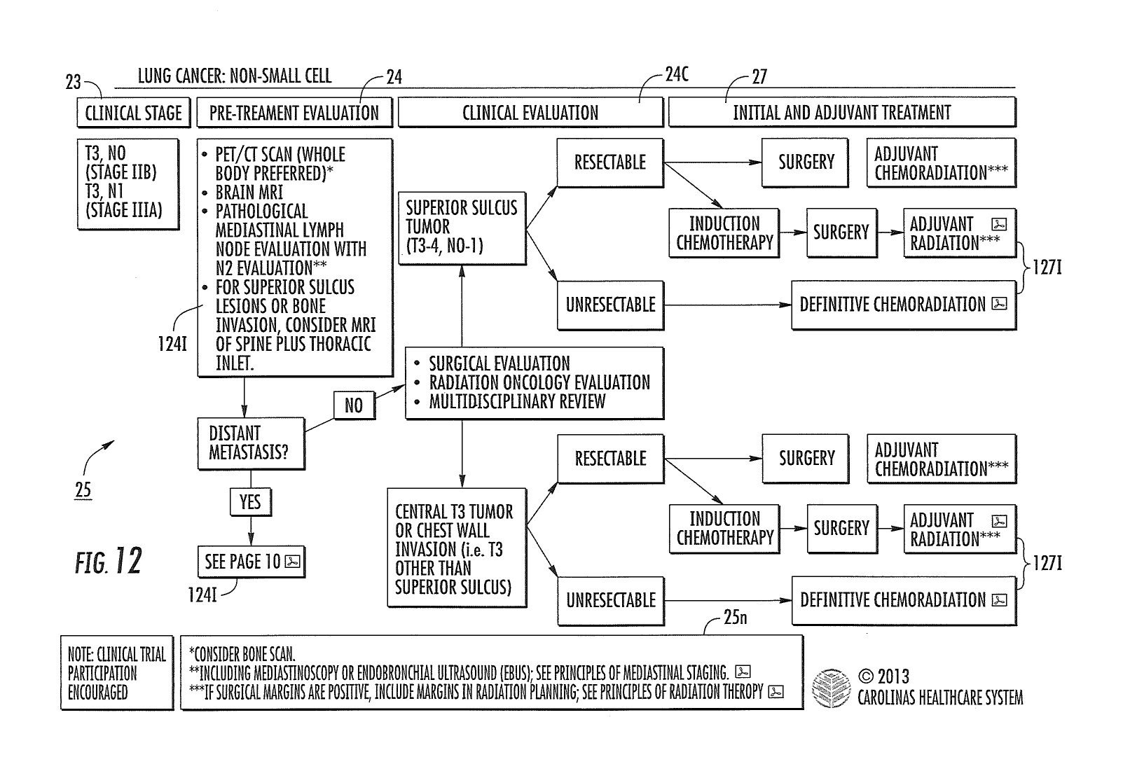

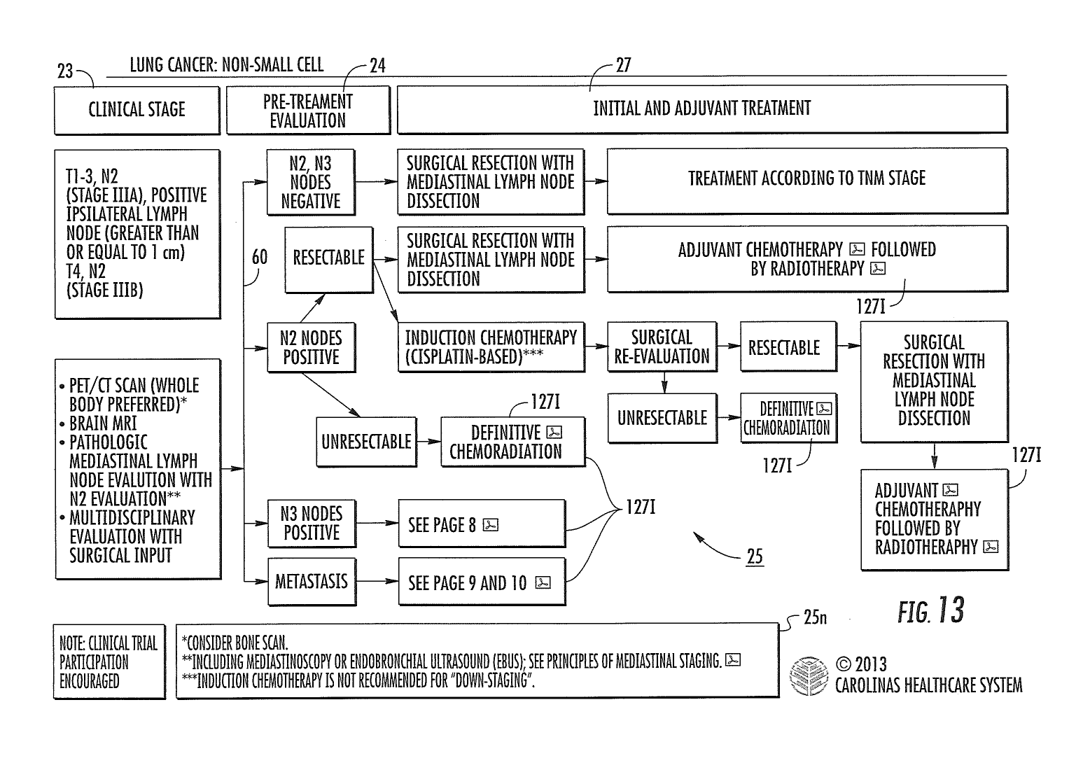

FIGS. 9-17 illustrate diagnosis pathways 25 with guidelines on a set of display windows providing evaluation (initial 22, and pretreatment 24 which can categorize clinical evaluation 24c (FIG. 12) as a part of the pretreatment evaluation 24) guidelines, clinical staging guidelines 23, post-operative surgical findings 27 with guidelines (FIG. 11), initial and adjuvant treatment guidelines 27 for lung cancer: non-small cell. These diagnostic clinical pathways 25 are associated with the overall clinical pathway 20 associated with the stage IV treatment pathways 40 shown in FIG. 1, for example. The windows 20w with the diagnosis pathways 25p can include notes 25n and information 122I, 124I, 126I, 127I in convenient summaries, packages and/or links in support of the different clinical steps/actions. For example, for cancer-based clinical diagnostic pathways, the pathways 25 can include staging principles (FIG. 13), adjuvant chemotherapy and radiotherapy treatment information 127I, with pin cites to relevant pages of an appended reference document for various patient indications on pretreatment evaluations (FIGS. 13, 14 and 15). The radiation therapy information 127I can include a packet of information including a general radiation therapy consent form, thoracic area radiation therapy consent form, a nutrition referral form, a patient rights and responsibilities document, patient education document, antioxidants fatigue, lump in throat/difficulty swallowing, mechanical soft diet, nausea and indigestion, fall prevention, skin care, support groups and spiritual support.

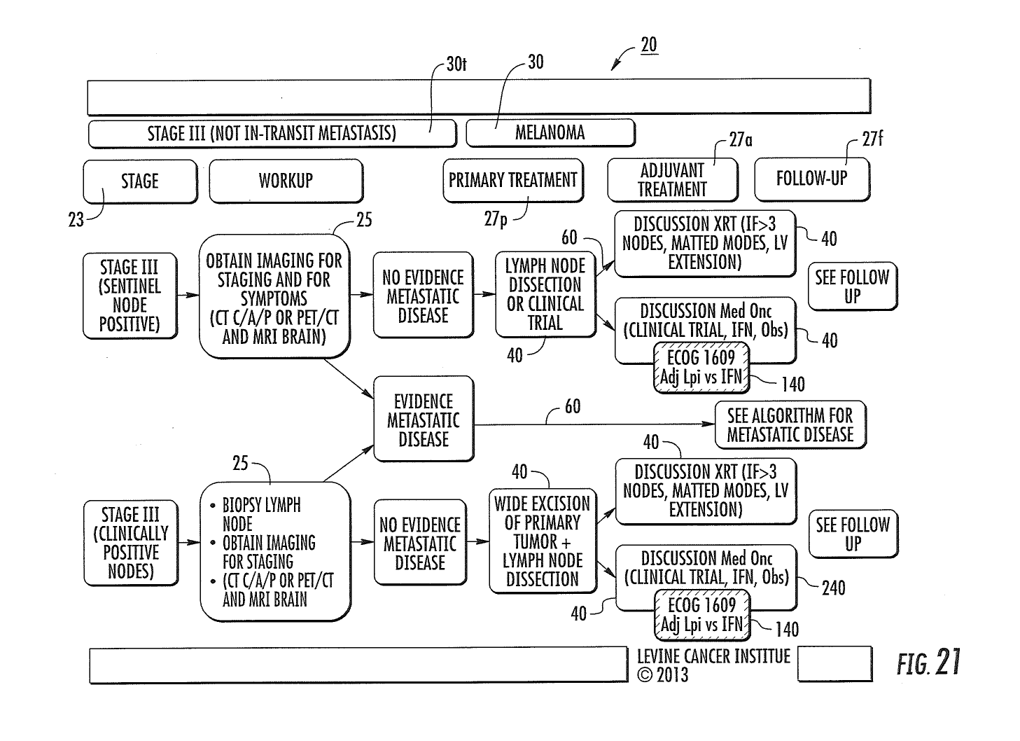

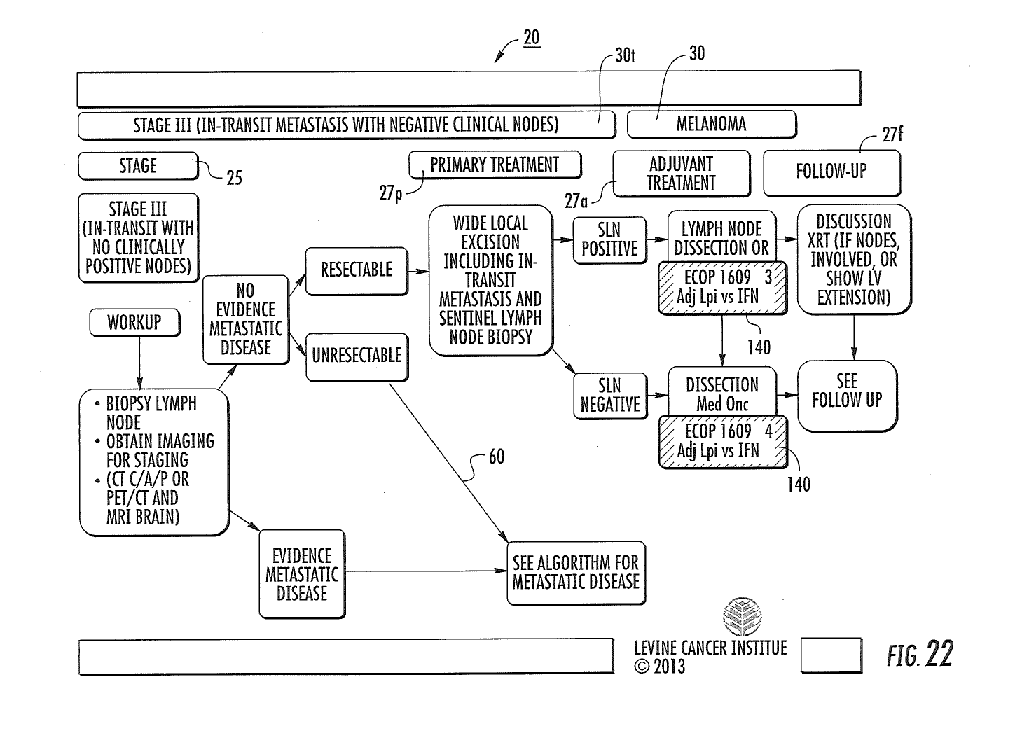

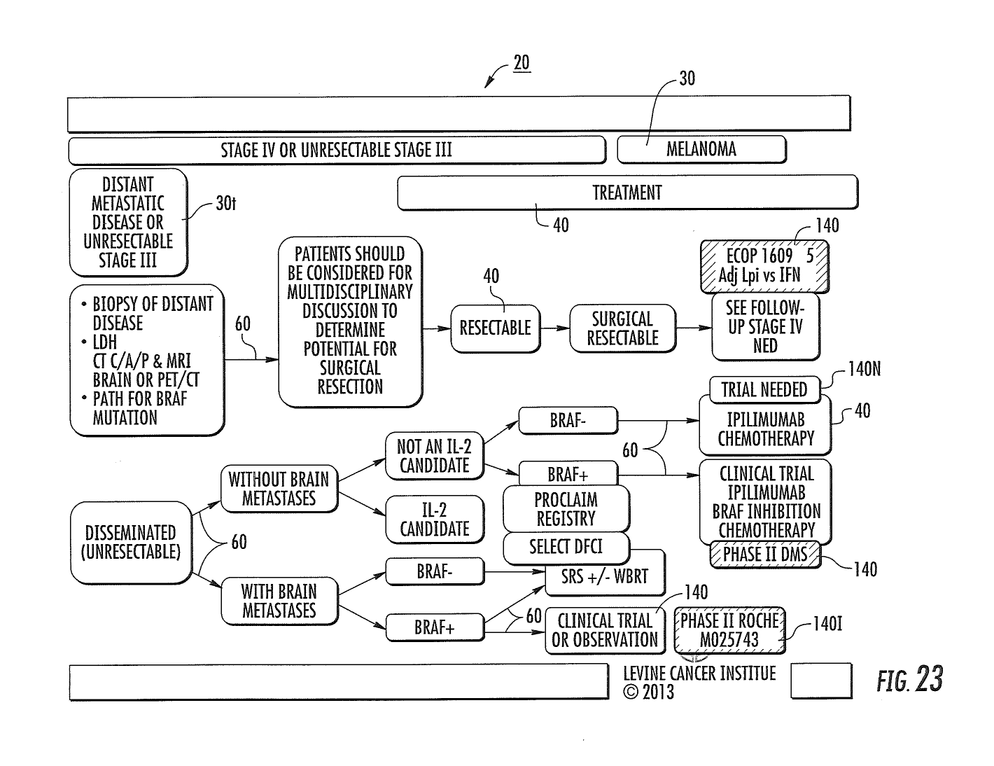

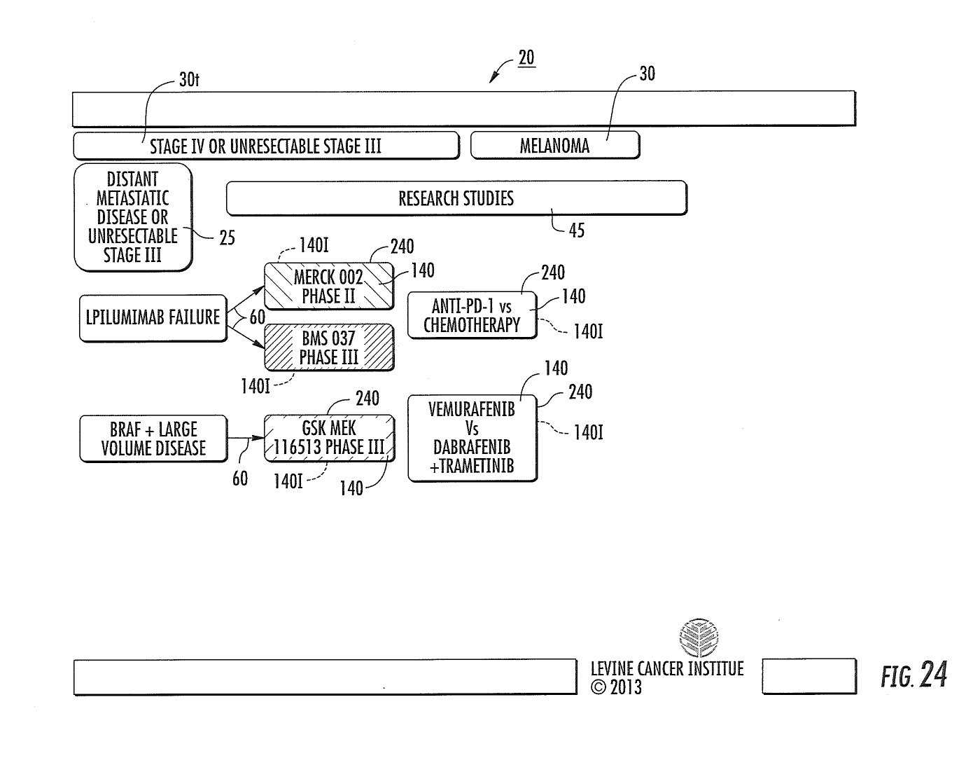

FIGS. 20-24 are exemplary windows or pages of content 20 of a clinical pathways system 10 for melanoma according to embodiments of the present invention. As shown, the clinical pathways 20 are for different stages of melanoma (which can also be identified as a subtype 30t of this disease 30). FIG. 20 is for Stage I-II, FIG. 21 is for Stage III (non in-transit metastasis), FIG. 22 is for Stage III (in-transit metastasis with negative clinical nodes), FIGS. 23 and 24 are for Stage IV or unresectable Stage III.

As shown, open clinical trials 140 and research studies 45 are shown at relevant therapy decision locations on the clinical pathways 20. For example, clinical trial 140 labeled as “ECOG 1609” is shown at five different therapy decision locations, twice on FIG. 21, twice on FIG. 22 and once on FIG. 23.

The clinical pathways 20 can be provided with a sequential layout of decision points and actions from initial evaluation, staging 23 and treatment 27 including primary 27p, adjuvant 27a and follow-up 27f, for example.

FIG. 23 illustrates that a clinical pathway window 20w can also have a box or other input with a “Trial Needed” request 140N which may be shown in a color different from open clinical trials 140. This may facilitate faster identification and sponsorship or research to initiate a suitable clinical trial where there is a specified need/request at a specified disease sub-type and treatment clinical pathway 40. However the “trial needed” option can also or alternatively be used as a section or institutional planning document and may not appear in an actual pathway tool for most or any physicians.

FIG. 24 shows that for specified subtypes 30t and staging 25, the clinical pathways system 10 can provide a window 20w with research studies 45 and treatment clinical pathway options 40 and links 240 to relevant information 240I facilitating these therapies.

Typically, as shown, the pathways 20 are provided in a left to right sequence or series of instructions, decision points and the like and the “flow” or sequence can be indicated with tethers 60. However, the pathways 20 can be provided top to bottom or even right to left or bottom to top or a combination of same.

The clinical trials 140 can be visually enhanced from other content, such as shown in a different color (e.g., yellow while other content is shown in a different color background) and/or in a “blinking” visual format so that user can be visually alerted as to the clinical trial option.

As will be appreciated by one of skill in the art, embodiments of the invention may be embodied as a method, system, data processing system, or computer program product. Accordingly, the present invention may take the form of an entirely software embodiment or an embodiment combining software and hardware aspects, all generally referred to herein as a “circuit” or “module.” Furthermore, the present invention may take the form of a computer program product on a non-transient computer usable storage medium having computer usable program code embodied in the medium. Any suitable computer readable medium may be utilized including hard disks, CD-ROMs, optical storage devices, a transmission media such as those supporting the Internet or an intranet, or magnetic or other electronic storage devices.

Computer program code for carrying out operations of the present invention may be written in an object oriented programming language such as Java, Smalltalk, C# or C++. However, the computer program code for carrying out operations of the present invention may also be written in conventional procedural programming languages, such as the “C” programming language or in a visually oriented programming environment, such as Visual Basic.

Certain of the program code may execute entirely on one or more of a user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). Typically, some program code executes on at least one web (hub) server and some may execute on at least one web client and with communication between the server(s) and clients using the Internet.

The invention is described in part below with reference to flowchart illustrations and/or block diagrams of methods, systems, computer program products and data and/or system architecture structures according to embodiments of the invention. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory or storage that can direct a computer or other programmable data processing apparatus to function in a particular manner, such that the instructions stored in the computer-readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowcharts and block diagrams of certain of the figures herein illustrate exemplary architecture, functionality, and operation of possible implementations of embodiments of the present invention. In this regard, each block in the flow charts or block diagrams represents a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order or two or more blocks may be combined, depending upon the functionality involved.

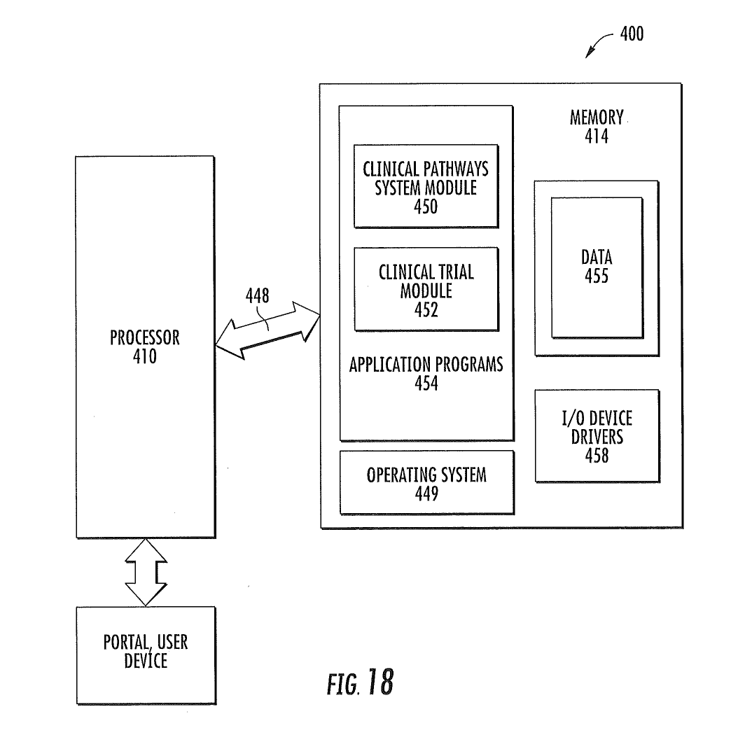

FIG. 18 is a schematic illustration of a circuit or data processing system 400 that can be used to provide the clinical pathway system 10. The circuits and/or data processing systems 400 may be incorporated in at least one digital signal processor in any suitable device or devices. As shown in FIG. 18, the at least one processor 410 communicates with and/or is integral with clients or local user devices and with memory 414 via an address/data bus 448. The at least one processor 410 can be any commercially available or custom microprocessor. The memory 414 is representative of the overall hierarchy of memory devices containing the software and data used to implement the functionality of the data processing system. The memory 414 can include, but is not limited to, the following types of devices: cache, ROM, PROM, EPROM, EEPROM, flash memory, SRAM, and DRAM.

FIG. 18 illustrates that the memory 414 may include several categories of software and data used in the data processing system: the operating system 449; the application programs 454; the input/output (I/O) device drivers 458; and data 455. The data 455 can include approved active clinical trial options, enrollment counts and enrollment active dates (open and closed) for respective clinical trials and may optionally include pending non-active clinical trials.

As will be appreciated by those of skill in the art, the operating systems 449 may be any operating system suitable for use with a data processing system, such as OS/2, AIX, or zOS from International Business Machines Corporation, Armonk, N.Y., Windows CE, Windows NT, Windows95, Windows98, Windows2000, WindowsXP, Windows Visa, Windows7, Windows CE or other Windows versions from Microsoft Corporation, Redmond, Wash., Palm OS, Symbian OS, Cisco IOS, VxWorks, Unix or Linux, Mac OS from Apple Computer, LabView, or proprietary operating systems.

The I/O device drivers 458 typically include software routines accessed through the operating system 449 by the application programs 454 to communicate with devices such as I/O data port(s), data storage 455 and certain memory 414 components. The application programs 454 are illustrative of the programs that implement the various features of the data processing system and can include at least one application, which supports operations according to embodiments of the present invention. Finally, the data 455 represents the static and dynamic data used by the application programs 454, the operating system 449, the I/O device drivers 458, and other software programs that may reside in the memory 414.

While the present invention is illustrated, for example, with reference to the Modules 450 and 452 being application programs in FIG. 18, as will be appreciated by those of skill in the art, other configurations may also be utilized while still benefiting from the teachings of the present invention. For example, the Modules and/or may also be incorporated into the operating system 449, the I/O device drivers 458 or other such logical division of the data processing system. Thus, the present invention should not be construed as limited to the configuration of FIG. 18 which is intended to encompass any configuration capable of carrying out the operations described herein. Further, one or more of modules, i.e., Modules 450, 452 can communicate with or be incorporated totally or partially in other components, such as separate or a single processor.

The I/O data port can be used to transfer information between the data processing system and another computer system or a network (e.g., the Internet) or to other devices controlled by the processor. These components may be conventional components such as those used in many conventional data processing systems, which may be configured in accordance with the present invention to operate as described herein.

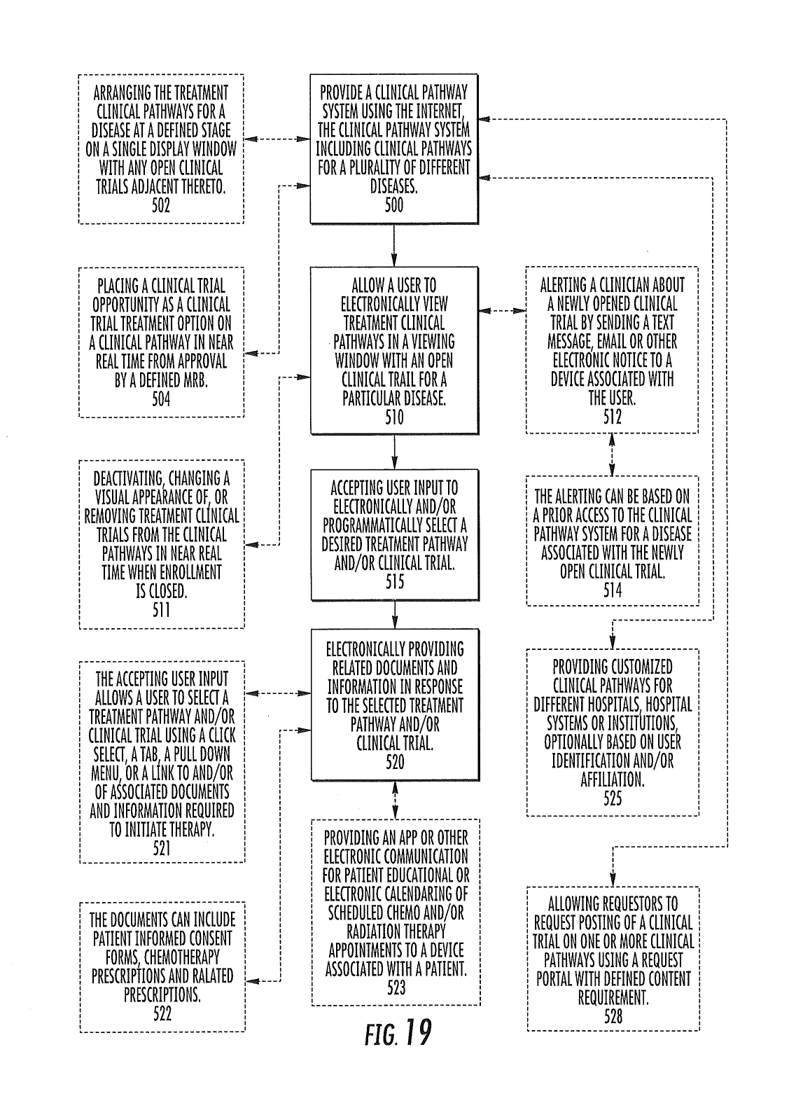

FIG. 19 is a flow chart of an exemplary method associated with clinical pathway systems that can be used by a clinician/doctor to refer to clinical pathways with near real time posting of clinical trial options according to embodiments of the present invention. As shown, a clinical pathway system is provided using the Internet, the clinical pathway system including clinical pathways for a plurality of different diseases (block 500). Allowing a user to electronically view treatment clinical pathways in a viewing window with an open clinical trial for a particular disease (block 510). Accepting user input to electronically and/or programmatically select a desired treatment pathway and/or clinical trial (block 515). Electronically provide related documents and information in response to the selected treatment pathway and/or clinical trial (block 520).

The treatment clinical pathways for a disease at a defined stage can be arranged on a single display window with any open clinical trials adjacent thereto or thereon (block 502). A clinical trial opportunity can be identified/placed as a clinical trial treatment option on a clinical pathway at a location associated with therapy options and/or decisions in near real time from approval by a defined MRB (block 504).

The clinical trial can be deactivated, changed in visual appearance, or removed from the clinical pathway and/or pathways in near real time when enrollment is closed (block 511).

The accepting user input can be configured to allow a user to select a treatment pathway or clinical trial using a click select, a tab, a pull down menu, or a link (e.g., hyperlink) of or to associated documents and information required or helpful to initiate therapy (block 521). The documents can include patient informed consent forms, chemotherapy prescriptions and related prescriptions (block 522).

The method can include alerting a clinician about a newly opened clinical trial by sending a text message, email or other electronic notice to a device associated with the user (block 512). Optionally, the alerting can be based on a prior access to the clinical pathway system for a particular disease associated with the new open clinical trial (block 514).

Customized clinical pathways can be provided for different hospitals, hospital systems or institutions, optionally based on user identification and/or affiliation (block 525).

Third party or enrolled requestors can be allowed to request posting of a clinical trial for one or more clinical pathways associated with one or more diseases using a request portal with defined content requirement (block 528).

An APP and/or other electronic communication with electronic patient educational and/or electronic calendaring of scheduled chemo and/or radiation therapy appointments can be provided/transmitted to a device associated with a patient (block 523).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method for providing clinical guidelines using a computer network, comprising:
providing a web-based service that provides a clinical pathways system using at least one server that allows users to access the clinical pathways system, wherein the clinical pathways system comprises a portal with a plurality of different defined clinical pathways for different diseases, wherein the clinical pathways include treatment clinical pathways that are displayed in a window on at least one display with an open clinical trial presented adjacent other treatment clinical pathways for a respective disease, wherein the treatment clinical pathways and any open clinical trial presented can each be selected by a user to electronically access related documents and information useful to initiate a selected therapy.

2. The method of claim 1, wherein the web-based service that provides the clinical pathways system is configured to provide custom clinical pathways for defined hospitals, hospital systems or institutions, and wherein the web-based service is configured to electronically select appropriate clinical pathways to present to a user according to a user's relationship or affiliation with the defined hospital, hospital system or institution.

3. The method of claim 1, wherein open clinical trials are identified and placed on clinical pathways in near real time to when a respective clinical trial has been approved by a defined medical board review.

4. The method of claim 1, wherein closed clinical trials are deactivated, removed or occluded from view on a respective clinical pathway in near real time from closure.

5. The method of claim 1, wherein a respective open clinical trial is shown on a display in a therapy decision window and/or page adjacent defined conventional treatment clinical pathways.

6. The method of claim 1, wherein the different diseases associated with the clinical pathways comprise a plurality of different cancers.

7. The method of claim 1, wherein the clinical pathways include a series of electronic windows or pages providing diagnostic clinical pathways that are sequentially placed before the treatment clinical pathways.

8. The method of claim 1, wherein the diagnostic pathways include display windows with relevant treatment notes and associated guidelines with electronic access to defined documents or information.

9. The method of claim 1, wherein a respective open clinical trial can be placed at more than one physical location or in more than one window or page along a clinical pathway for a particular disease and/or in more than one window or page associated with a pre-treatment, front line treatment or post-treatment, in a respective clinical pathway to thereby facilitate doctor awareness of applicability of the clinical trial for different relevant therapy decision points along a clinical pathway.

10. The method of claim 1, wherein a respective open clinical trial can be concurrently presented in different clinical pathways for different diseases.

11. The method of claim 1, further comprising electronically automatically notifying a user that previously accessed a disease-specific clinical pathway in the clinical pathway of a system of a newly opened clinical trial for that disease-specific clinical pathway.

12. The method of claim 11, wherein the automatic notification includes a hyperlink to a window, page or location associated with the newly opened clinical trial in the clinical pathway.

13. The method of claim 1, further comprising providing a list of pending clinical trials on a page or window correlated to a target disease associated with one or more of the clinical pathways.

14. The method of claim 1, further comprising providing a research study input and/or notice on a window or page associated with a respective clinical pathway at a location relevant to a specimen needed for the research, the research study input and/or notice providing electronic access to relevant documents including a patient informed consent form, researcher contact data and any special or noted specimen collection protocol.

15. The method of claim 1, further comprising electronically providing a requestor page or pages with a defined standardized set of inputs allowing a user to request that a clinical trial opportunity be included in the clinical pathways system for patient recruitment.

16. The method of claim 15, wherein the defined set of inputs includes, a drug associated with the clinical trial, related information about the drug and trial, target treatment, patient eligibility information, patient informed consent form, and location of where the requested clinical trial will be carried out.

17. The method of claim 1, further comprising electronically providing pending clinical trials on a window or page adjacent associated conventional defined treatment clinical pathways with a visual presentation that is different from the conventional defined treatment clinical pathways and any open clinical trials.

18. The method of claim 1, further comprising electronically providing visual indicia of a location associated with where the open clinical trial is being carried out at least when the open clinical trial is carried out away from a patient home or base hospital, hospital system or institution.

19. The method of claim 15, wherein the clinical pathways system is configured to indicate a requestor patient clinical trial as a clinical trial adjacent or in a window of other treatment clinical pathways with visual indicia that the requestor clinical trial is in a remote location away from a patient home base.

20. A clinical pathways system comprising:
at least one web server in communication with a global computer network configured to provide a web-based service that hosts a clinical pathways system,
wherein the clinical pathways system comprises at least one portal for users to access the clinical pathway system, wherein the clinical pathways system is configured to provide a series of electronic pages and/or windows having a visual presentation of clinical pathways associated with a plurality of different disease states, wherein the clinical pathways comprise treatment clinical pathways configured to be shown in at least one window and/or page on a display with an open clinical trial presented adjacent other treatment clinical pathways, wherein the treatment clinical pathways and any open clinical trial presented can each be selected by a user to electronically access related documents and information useful to initiate a selected therapy associated with the selected clinical pathway or open clinical trial.

21-34. (canceled)

35. A computer program product, the computer program product comprising:
a non-transitory computer readable storage medium having computer readable program code, the computer-readable program code comprising:
computer readable program code configured to provide a clinical pathways system using at least one server that allows users to access the clinical pathways system, wherein the clinical pathways system comprises a portal with a plurality of different defined clinical pathways for different diseases;
computer readable program code configured to allow a user to select a desired clinical treatment pathway from one of the defined different clinical pathways for different diseases for display in a window or windows on at least one display;
computer readable program code configured to present an open clinical trial adjacent other treatment clinical pathways for a respective disease; and
computer readable program code configured to provide electronic access to related documents and information useful to initiate a therapy in a selected treatment clinical pathway and any open clinical trial in the selected treatment clinical pathway.

36. (canceled)

37. A system comprising:
at least one processor comprising computer program code that, when executed, causes the at least one processor to:
provide a clinical pathways system using at least one server that allows users to access the clinical pathways system, wherein the clinical pathways system comprises a portal with a plurality of different defined clinical pathways for different diseases;
allow a user to select a desired clinical treatment pathway from one of the defined different clinical pathways for different diseases for display in a window or windows on at least one display;
present an open clinical trial adjacent other treatment clinical pathways for a respective disease; and
provide electronic access to related documents and information useful to initiate a therapy in a selected treatment clinical pathway and any open clinical trial in the selected treatment clinical pathway.

38. (canceled)
